(19) United States
(12) Patent Application Publication
(10) Pub. No.: US 2026/0347054 A1
(43) Pub. Date: Nov. 5, 2026

(54) HIGH-STRENGTH PACKAGING CLOSURES FORMED BY ULTRASONIC WELDING

(71) Applicant: KWIK LOK CORPORATION, Union Gap, WA (US)

(72) Inventors: Erik T. BECK, Union Gap, WA (US); Bruce C. GOODELL, Union Gap, WA (US); Roger Keith HART, Union Gap, WA (US); Viktoria V. PAKHNYUK, Union Gap (WA); Guangyu TONG, Union Gap, WA (US); Ryan S. TOWRY, Union Gap, WA (US)

(21) Appl. No.: 19/120,718

(22) PCT Filed: Oct. 2, 2023
(86) PCT No.: PCT/US2023/075675

§ 371 Date: Apr. 11, 2025

Related U.S. Application Data
(60) Provisional application No. 63/415,580, filed on Oct. 12, 2022.

(51) Int. Cl. B65D 33/00; B29C 65/00; B29C 65/08; B29L 31/00; B29L 31/56; B65D 33/16

(52) U.S. Cl. CPC B65D 33/004; B29C 65/082; B29C 66/472; B29C 66/71; B65D 33/1625; B29L 2031/56; B29L 2031/744; B65D 2203/02

(57) ABSTRACT

Disclosed herein are bonded articles formed by ultrasonic welding, and methods for preparing the bonded articles.

### BACKGROUND

This disclosure relates to high-strength plastic packaging closures that can quickly and securely grip and hold closed the necks of flexible packages.

FIG. 1 illustrates a packaging 100, which may be a sealed bag (e.g., a plastic bread bag), where the sealed bag 100 includes a lower portion or base 102 opposite an upper portion or top 104 with an intermediary portion or neck 106 located between the base 102 and the top 104. In this illustration, the neck 106 is proximate to the top 104 of the sealed bag 100, and the sealed bag 100 includes an opening 108 at the top 104 proximate to the neck 106, in which a product (not shown), such as a loaf of bread, can be held within the sealed bag 100 by virtue of a removably couplable closure 110 coupled to the neck 106 of the sealed bag 100 to hold the opening 108 in a closed condition.

In some applications, the closure 110 can be bonded to a label that displays product and/or tracking information. FIG. 2 illustrates a bonded packaging closure 112 containing a removably couplable closure 110 bonded to a label 114 on which product and/or tracking information is printed. In these applications, an adhesive is typically used to bond the closure 110 and the label 114 together at an area of overlap 116. FIG. 3 shows a side view of the bonded packaging closure 112 as viewed along the plane P1 of FIG. 2, in which the sandwiched adhesive 118 bonds the closure 110 to the label 114 within the area of overlap 116.

The use of adhesives for bonding the plastic components of packaging closures imposes certain limitations on both the construction and properties of the bonded articles. The effectiveness of an adhesive for bonding plastics, for example, is closely tied to the respective characteristics of the adhesive and plastic components. It is well known that plastics having low surface energy (e.g., hydrophobic plastics) are more difficult to bond together using typical commercial adhesives. For this reason, bonded packaging closures known in the relevant art often employ higher surface energy plastics, such as high impact polystyrenes (HIPSs), to ensure sufficient bonding strength between the closure and the label.

The use of an adhesive for bonding the plastic components of packaging closures can also limit the functional characteristics of bonded articles based on the properties of the adhesive itself. Whereas the plastic closure and label of a bonded article may be expected to offer durability and strength under extreme conditions of temperature, humidity and/or radiation, it is well recognized that typical commercial adhesives offer relatively low durability and strength under extreme conditions compared to the plastic substrates. Consequently, bonded packaging closures that are currently used in the relevant art are often functionally limited to relatively mild conditions of temperature, humidity and/or radiation.

There is a need to develop alternative methods for bonding the plastic components of packaging closures that avoid the use of adhesives. A need also exists to develop alternative methods for bonding low surface energy plastics, such as polyolefins, that may be less effectively bound using adhesives. There is also a need to develop alternative methods for bonding plastics together to obtain bonded articles that exhibit high durability and strength over a wide range of temperature, pressure, humidity and radiation exposure. There is also a need to develop bonded articles that are suitable for recycling, in which the closure and label components can be recycled in the same stream without the need for detachment.

### BRIEF SUMMARY

Disclosed herein are bonded articles formed by using ultrasonic welding techniques that enable the production of packaging closures capable of withstanding extreme conditions of temperature, pressure, humidity and/or radiation exposure. In some embodiments these bonded articles are suitable for being recycled without the need for the closure and label components to be detached.

It was discovered that ultrasonic welding can reliably bond low surface energy plastics in a high-throughput manner to produce extremely durable and strong packaging closures. As illustrated in Examples 1 and 2, described herein, extremely thin polypropylene labels can be reliably bound to polypropylene closures to obtain high-strength packaging closures. Such bonded articles are suitable for recycling without the need for the closure and label components to be detached.

Various embodiments disclosed herein provide bonded articles containing a label substrate bonded to a closure substrate via an ultrasonically bonded region. Other embodiments relate to methods for preparing bonded articles using ultrasonic energy.

One embodiment relates to bonded articles comprising a label substrate bonded to a closure substrate via a bonding region, wherein (a) the label substrate comprises a first polymer, the closure substrate comprises a second polymer, and the first and second polymers are chemically compatible for ultrasonic bonding together, (b) the label substrate is in the form of a sheet having a thickness of less than about 0.02 inch, and the closure substrate is in the form of a flat plastic body having a thickness that is greater (e.g., at least 2.5 times greater) than the thickness of the label substrate and having an elongation at break of 25% or less, (c) the bonding region comprises a portion of the label substrate laterally bonded to a portion of the closure substrate, wherein the portion of the label substrate has a plurality of protrusions extending outwardly from a first conjoined surface, and the portion of the closure substrate has a plurality of complementary depressions extending inwardly from a second conjoined surface that faces the first conjoined surface, wherein at least one protrusion on the first conjoined surface of the label substrate bonds to at least one complementary depression on the second conjoined surface of the closure substrate, and (d) the bonding region bonds the label substrate to the closure substrate with a lap shear strength of at least 100 N.

Another embodiment relates to methods for the preparing bonded articles described herein by performing the steps of (i) placing the label substrate atop the closure substrate such that a lower flat portion of the label substrate contacts an upper flat portion of the closure substrate, wherein the contacted lower and upper flat portions constitute an overlap region, and (ii) while applying a downward force from an ultrasonic sonotrode to an upper flat portion of the label substrate within the overlap region, applying ultrasonic energy from the ultrasonic sonotrode to the upper flat portion of the label substrate, thereby causing a portion of the first polymer in the overlap region and a portion of the second polymer in the overlap region to bond together and form the bonding region of the bonded article.

### BRIEF DESCRIPTION OF THE SEVERAL VIEWS OF THE DRAWINGS

FIG. 1 is a front perspective view of an illustrative packaging in which a bag is held closed by virtue of a removably couplable closure;

FIG. 2 illustrates a bonded packaging disclosure containing product label bonded to a removably couplable closure using an adhesive;

FIG. 3 shows a side view of the bonded packaging disclosure of FIG. 2 in which the adhesive is sandwiched between the closure and the label;

FIG. 4 illustrates a bonded article of the present disclosure as depicted from above the plane of the bonded article;

FIG. 5 shows a side view of the bonded article of FIG. 4;

FIG. 6 illustrates a bonding region including an interface region containing blended materials from the label substrate and the closure substrate;

FIG. 7 illustrates a portion of a multi-closure strip;

FIG. 8 illustrates a bonded article in which the lateral width of the closure substrate is less than the lateral width of the label substrate;

FIG. 9 illustrates the direction of travel and the linear length of a multi-closure strip of FIG. 7 used in serial production of bonded articles;

FIG. 10 shows the bonded article produced by a method of Example 1;

FIG. 11 shows the separated label and closure substrates following the lap shear testing of the bonded article of FIG. 10;

FIG. 12 shows a close-up of the separated label and closure substrates, in reassembled form, illustrating how each of the protrusions on the label substrate correspond to complementary depressions on the closure substrate; and

FIG. 13 is a bar chart summarizing the lap shear strength data for the bonded articles of Comparative Example 1, Comparative Example 2, Example 1 and Example 2.

The following detailed description is intended to illustrate non-limiting embodiments so that others skilled in the art can more fully understand the technical solution of the present disclosure, its principles and practical applications, and so that others skilled in the art can modify and implement the present disclosure in various manners that can be optimally adapted to the requirements of specific applications.

### DETAILED DESCRIPTION

Various embodiments of the present disclosure provide bonded articles comprising a label substrate bonded to a closure substrate via a bonding region prepared using ultrasonic welding. In particular, bonded articles of the present disclosure can be useful as high-strength and high-durability packaging closures for flexible packages, including flexible packages for food products and other products that may be subjected to harsh processing and storage conditions. Some bonded articles disclosed herein are suitable for recycling without the need to separate the closure substrate from the label substrate.

### DEFINITIONS

As used herein, the term “about” means that the described parameter may include a deviation of ±5 percent. For example, a thickness of about 0.06 inch would encompass a thickness ranging from 0.057 inch to 0.063 inch. For example, an angle of about 0 degrees would encompass angles ranging from 0 to 5 degrees.

As used herein, the term “bond” or “bonding” refers to a process of physically joining two substrates of the same or different materials. In some embodiments, the bonding process produces heat, friction, and/or deformation of the substrates, one or all of which may contribute to joining the substrates to create bond. In some embodiments, the bonding process may be localized in defined regions of the substrates.

As used herein, “chemically compatible” polymers, or polymers that are “chemically compatible for ultrasonic bonding together,” refer to polymers that possess chemical characteristics enabling the polymers to be bonded together using ultrasonic energy. Chemical characteristics that enable polymers to be chemically compatible may include similar polymer compositions or classes (e.g., polymers A and B are both, for example, polyolefins), similar melting points (e.g., polymers A and B have melting points within, for example, 20 °C), similar melt flow rates (e.g., polymers A and B have melt flow rates within, for example, 4 g/10 min), and similar polymer morphologies (e.g., polymers A and B are both amorphous polymers, or polymers A and B are both semi-crystalline polymers).

As used herein, the term “elongation at break” refers to a measurement of how much a material can be stretched, as a percentage of its original dimensions, at the point of breakage. Measures of elongation at break that are disclosed herein were obtained using the standard ASTM D 638.

As used herein, the term “flexural modulus” refers to an intensive property that is computed as the ratio of stress to strain in flexural deformation, or the tendency for a material to resist bending. Measures of flexural modulus that are disclosed herein were obtained using the standard ASTM D 790.

As used herein, the term “impact strength” refers to the resistance of a material to fracture by a blow, expressed in terms of the amount of energy absorbed before fracture. Measures of impact strength that are disclosed herein were obtained using the standard ASTM D 256.

As used herein, the term “independently” means that the described features are selected independently from one another. For example, when a first polymer and a second polymer independently comprise a polyolefin, then the first polymer may include a different polyolefin than the polyolefin contained in the second polymer, or the first and second polymers may include the same polyolefin.

As used herein, the term “Izod impact strength” refers to a single point test that measures a material's resistance to impact from a swinging pendulum. Izod impact is defined as the kinetic energy needed to initiate fracture and continue the fracture until the specimen is broken. Measures of Izod impact strength that are disclosed herein were obtained using the standard ASTM D 256.

As used herein, the term “lap shear strength” refers to a measurement of the maximum measured force that a bonded article can withstand in a plane, where an exerted shear force is moving the two substrates of the bonded article in opposite directions. Measures of lap shear strength that are disclosed herein were obtained using the standard ASTM D3163-01. Lap shear strength tests were conducted on bonded articles at 50 mm/min pull rate on universal testing machine, such that thicknesses of the closure substrate and the label substrate were 0.030 inch and 0.010 inch, respective, the width of the closure substrate and the label substrate were both ⅞ inch, and the bonding region of overlap between the closure substrate and the label substrate was 5/16 inch. Bonded article samples were conditioned in controlled lab environment at 70-72 °F (21-22 °C) and 20-22% humidity for a 24-hour period prior to the lap shear strength testing, with 5 samples per test.

As used herein, the term “melting point” refers to a temperature (or average temperature of a temperature range) at which a (semi)crystalline substance transitions from a (semi) crystalline state to a liquid state. Measures of melting point that are disclosed herein were obtained using the standard ASTM D3418.

As used herein, the term “melt flow rate” refers to a measure of the ease of flow (in units of g/10 min) of a melted plastic. Measures of melt flow rate that are disclosed herein were obtained using the standard ASTM D1238-10.

As used herein, the term “Shore D hardness” refers to a measurement of the resistance that a material has to indentation. Measures of Shore D hardness that are disclosed herein were obtained using the standard ASTM D 2240.

As used herein, the term “Rockwell R hardness” refers to a measure of the resistance that a material has to indentation. The Rockwell test measures the depth of penetration of an indenter under a large load (major load) compared to the penetration made by a preload (minor load).

Measures of Rockwell R harness that are disclosed herein were obtained using the standard ATMS D 785.

As used herein, the term “sonotrode” or “horn” are used interchangeably and refer to a tool used in ultrasonic welding to create ultrasonic vibrations (vibrational energy) that are passed to an object or objects being welded (bonded) together.

As used herein, the term “surface energy” refers to a measure of excess atomic energy found at the surface of a material in comparison to at its bulk. In this disclosure surface energy is measured as dyne surface energy using commercial dyne pens, where a “dyne” level disclosed herein is a measurement of surface energy in energy units referred to as Dyne/cm (1 Dyne=0.00001 Newtons).

As used herein, the term “tensile modulus” refers to a mechanical property of elastic materials, and relates the deformation of a material to the amount of force needed to deform it by applying tension. Measures of tensile modulus that are disclosed herein were obtained using the standard ASTM D 638.

As used herein, the term “tensile strength” refers to the amount of load or stress that a material can handle until it yields and breaks under tension. Measures of tensile strength that are disclosed herein were obtain using the standard ASTM D 638.

### Bonded Articles

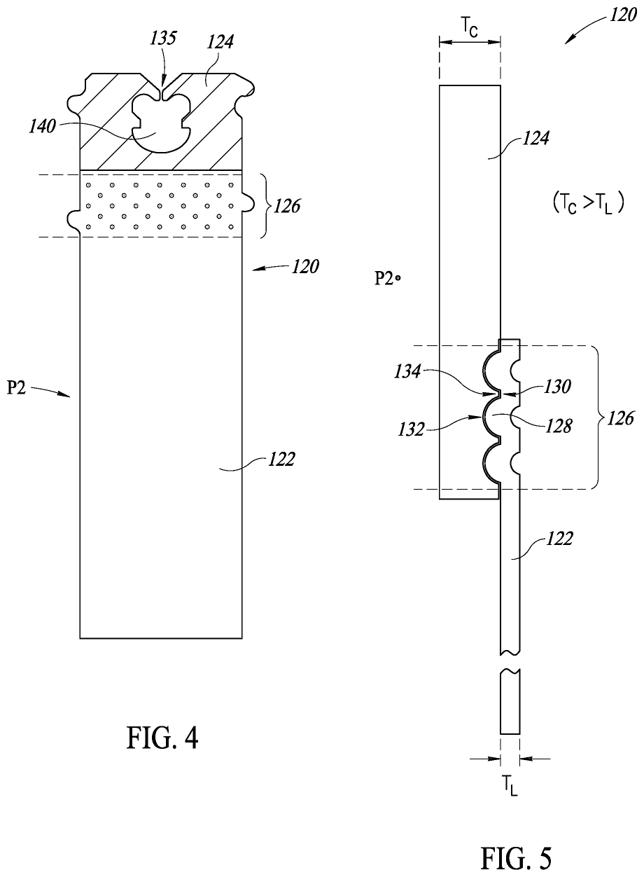

FIG. 4 illustrates a bonded article 120 of one embodiment of the present disclosure, which comprises a label substrate 122 bonded to a closure substrate 124 via a bonding region 126. The label substrate 122 comprises a first polymer, and the closure substrate 124 comprises a second polymer, wherein the first and second polymers are chemically compatible for ultrasonic bonding.

Polymers that are chemically compatible for ultrasonic bonding together are typically, for not exclusively, of the same polymer composition or class. For example, amorphous polymers of the same class are generally chemically compatible for ultrasonic bonding, and semi-crystalline polymers of the same class are generally chemically compatible for ultrasonic bonding. In some embodiments, amorphous polymers of different polymer compositions or classes may be chemically compatible for ultrasonic bonding.

In some embodiments the first and second polymers independently comprise at least one selected from a polyolefin, a polyacrylate, a polystyrene (PS), a styrene-butadiene (SB) polymer, a polyacrylonitrile (PAN), an acrylonitrile-butadiene-styrene (ABS) polymer, a polyacrylonitrile-ethylene-propylene-diene-styrene copolymer (A-EPDM), a polycarbonate (PC), an ABS/PC alloy, a polyester, a polyhydroxyalkanoate, a phenolic resin, a urea resin, a melamine resin, an alkyd resin, an epoxy resin, a polylactic acid (PLA), a polyurethane (PU), a polyether, a polyvinyl alcohol (PVA), a polyamide (PA), a polyetherimide (PEI), a polyethersulfone (PES), a polysulfone, a polyvinylchloride (PVC), a polyoxymethylene (POM), a styrene-acrylonitrile (SAN), an acrylonitrile-styrene-acrylate (ASA), a styrene-acrylate (NAS), an SAN-NAS-ASA alloy, a polybutylene terephthalate (PBT), a PBT/PC alloy, a polyethylene tetraphthalate (PET), a polyether ether ketone (PEEK), a poly(phenylene oxide) (PPO), a polyphenylene sulfide (PPS), a polysaccharide, a fluoropolymer, a liquid crystal polymer (LCP), or copolymers thereof.

In other embodiments the first and second polymers independently comprise at least one selected from a polyacrylate, a polystyrene (PS), a styrene-butadiene (SB) polymer, an acrylonitrile-butadiene-styrene (ABS) polymer, a polycarbonate (PC), an ABS/PC alloy, a polyetherimide (PEI), a polyethersulfone (PES), a polysulfone, a polyvinylchloride (PVC), a styrene-acrylonitrile (SAN), an acrylonitrile-styrene-acrylate (ASA), a styrene-acrylate (NAS), a polysaccharide, a SAN-NAS-ASA alloy, a PBT/PC alloy, and a poly(phenylene oxide) (PPO). In some embodiments these polymers may be combined with at least one additional polymer selected from a polyacrylonitrile (PAN), a polyacrylonitrile-ethylene-propylene-diene-styrene copolymer (A-EPDM), a polyester, a polyhydroxyalkanoate, a phenolic resin, a urea resin, a melamine resin, an alkyd resin, an epoxy resin, a polylactic acid (PLA), a polyurethane (PU), a polyether, or a polyvinyl alcohol (PVA). In some embodiments each of these first and second polymers are amorphous polymers.

In some embodiments the first and second polymers are both a polyacrylate. For example, the first and second polymer may be the same polyacrylate. In other embodiments the first polymer is a polyacrylate and the second polymer is an acrylonitrile-butadiene-styrene (ABS) polymer; while in other embodiments the second polymer is a polyacrylate and the first polymer is an acrylonitrile-butadiene-styrene (ABS) polymer. In other embodiments the first polymer is a polyacrylate and the second polymer is an ABS/PC alloy; while in other embodiments the second polymer is a polyacrylate and the first polymer is an ABS/PC alloy. In other embodiments the first polymer is a polyacrylate and the second polymer is a poly(phenylene oxide) (PPO); while in other embodiments the second polymer is a polyacrylate and the first polymer is a poly(phenylene oxide) (PPO). In other embodiments the first polymer is a polyacrylate and the second polymer is a polycarbonate (PC); while in other embodiments the second polymer is a polyacrylate and the first polymer is a polycarbonate (PC). In other embodiments the first polymer is a polyacrylate and the second polymer is a SAN-NAS-ASA alloy; while in other embodiments the second polymer is a polyacrylate and the first polymer is a SAN-NAS-ASA alloy.

In some embodiments the first and second polymers are both a polystyrene (PS). For example, the first and second polymer may be the same polystyrene (PS). In other embodiments the first polymer is a polystyrene (PS) and the second polymer is an styrene-butadiene (SB) polymer; while in other embodiments the second polymer is a polystyrene (PS) and the first polymer is an styrene-butadiene (SB) polymer. In other embodiments the first polymer is a polystyrene (PS) and the second polymer is an acrylonitrile-butadiene-styrene (ABS) polymer; while in other embodiments the second polymer is a polystyrene (PS) and the first polymer is an acrylonitrile-butadiene-styrene (ABS) polymer. In other embodiments the first polymer is a polystyrene (PS) and the second polymer is a poly(phenylene oxide) (PPO); while in other embodiments the second polymer is a polystyrene (PS) and the first polymer is a poly(phenylene oxide) (PPO). In other embodiments the first polymer is a polystyrene (PS) and the second polymer is an a styrene-acrylonitrile (SAN); while in other embodiments the second polymer is a polystyrene (PS) and the first polymer is a styrene-acrylonitrile (SAN). In other embodiments the first polymer is a polystyrene (PS) and the second polymer is a SAN-NAS-ASA alloy; while in other embodiments the second polymer is a polystyrene (PS) and the first polymer is a SAN-NAS-ASA alloy.

In some embodiments the first and second polymers are both a styrene-butadiene (SB) polymer. For example, the first and second polymer may be the same styrene-butadiene (SB) polymer.

In some embodiments the first and second polymers are both an acrylonitrile-butadiene-styrene (ABS) polymer. For example, the first and second polymer may be the same acrylonitrile-butadiene-styrene (ABS) polymer. In other embodiments the first polymer is an acrylonitrile-butadiene-styrene (ABS) polymer and the second polymer is an ABS/PC alloy; while in other embodiments the second polymer is an acrylonitrile-butadiene-styrene (ABS) polymer and the first polymer is an ABS/PC alloy. In other embodiments the first polymer is an acrylonitrile-butadiene-styrene (ABS) polymer and the second polymer is a polycarbonate (PC); while in other embodiments the second polymer is an acrylonitrile-butadiene-styrene (ABS) polymer and the first polymer is a polycarbonate (PC). In other embodiments the first polymer is an acrylonitrile-butadiene-styrene (ABS) polymer and the second polymer is a polyvinylchloride (PVC); while in other embodiments the second polymer is an acrylonitrile-butadiene-styrene (ABS) polymer and the first polymer is a polyvinylchloride (PVC). In other embodiments the first polymer is an acrylonitrile-butadiene-styrene (ABS) polymer and the second polymer is a styrene-acrylonitrile (SAN); while in other embodiments the second polymer is an acrylonitrile-butadiene-styrene (ABS) polymer and the first polymer is a styrene-acrylonitrile (SAN). In other embodiments the first polymer is an acrylonitrile-butadiene-styrene (ABS) polymer and the second polymer is a SAN-NAS-ASA alloy; while in other embodiments the second polymer is an acrylonitrile-butadiene-styrene (ABS) polymer and the first polymer is a SAN-NAS-ASA alloy. In other embodiments the first polymer is an acrylonitrile-butadiene-styrene (ABS) polymer and the second polymer is a polystyrene (PS); while in other embodiments the second polymer is an acrylonitrile-butadiene-styrene (ABS) polymer and the first polymer is a polystyrene (PS). In other embodiments the first polymer is an acrylonitrile-butadiene-styrene (ABS) polymer and the second polymer is a poly(methyl methacrylate) (PMMA); while in other embodiments the second polymer is an acrylonitrile-butadiene-styrene (ABS) polymer and the first polymer is a poly(methyl methacrylate) (PMMA).

In some embodiments the first and second polymers are both a polycarbonate (PC). For example, the first and second polymer may be the same polycarbonate (PC). In other embodiments the first polymer is a polycarbonate (PC) and the second polymer is a poly(phenylene oxide) (PPO); while in other embodiments the second polymer is a polycarbonate (PC) and the first polymer is a poly(phenylene oxide) (PPO). In other embodiments the first polymer is a polycarbonate (PC) and the second polymer is a polyetherimide (PEI); while in other embodiments the second polymer is a polycarbonate (PC) and the first polymer is a polyetherimide (PEI). In other embodiments the first polymer is a polycarbonate (PC) and the second polymer is a polysulfone; while in other embodiments the second polymer is a polycarbonate (PC) and the first polymer is a polysulfone. In other embodiments the first polymer is a polycarbonate (PC) and the second polymer is a polysulfone; while in other embodiments the second polymer is a polycarbonate (PC) and the first polymer is a polysulfone. In other embodiments the first polymer is a polycarbonate (PC) and the second polymer is a PBT/PC alloy; while in other embodiments the second polymer is a polycarbonate (PC) and the first polymer is a PBT/PC alloy. In other embodiments the first polymer is a polycarbonate (PC) and the second polymer is an ABS/PC alloy; while in other embodiments the second polymer is a polycarbonate (PC) and the first polymer is an ABS/PC alloy. In other embodiments the first polymer is a polycarbonate (PC) and the second polymer is a poly(methyl methacrylate) (PMMA); while in other embodiments the second polymer is a polycarbonate (PC) and the first polymer is a poly(methyl methacrylate) (PMMA).

In some embodiments the first and second polymers are both an ABS/PC alloy. For example, the first and second polymer may be the same ABS/PC alloy. In other embodiments the first polymer is an ABS/PC alloy and the second polymer is a PBT/PC alloy; while in other embodiments the second polymer is an ABS/PC alloy and the first polymer is a PBT/PC alloy. In other embodiments the first polymer is an ABS/PC alloy and the second polymer is a poly(methyl methacrylate) (PMMA); while in other embodiments the second polymer is an ABS/PC alloy and the first polymer is a poly(methyl methacrylate) (PMMA).

In some embodiments the first and second polymers are both a polyetherimide (PEI). For example, the first and second polymer may be the same polyetherimide (PEI). In other embodiments the first polymer is a polyetherimide (PEI) and the second polymer is a polybutylene terephthalate (PBT); while in other embodiments the second polymer is a polyetherimide (PEI) and the first polymer is a polybutylene terephthalate (PBT).

In some embodiments the first and second polymers are both a polyethersulfone (PES). For example, the first and second polymer may be the same polyethersulfone (PES).

In some embodiments the first and second polymers are both a polysulfone. For example, the first and second polymer may be the same polysulfone.

In some embodiments the first and second polymers are both a polyvinylchloride (PVC). For example, the first and second polymer may be the same polyvinylchloride (PVC).

In some embodiments the first and second polymers are both a styrene-acrylonitrile (SAN). For example, the first and second polymer may be the same styrene-acrylonitrile (SAN). In other embodiments the first polymer is styrene-acrylonitrile (SAN) and the second polymer is a poly(methyl methacrylate) (PMMA); while in other embodiments the second polymer is styrene-acrylonitrile (SAN) and the first polymer is a poly(methyl methacrylate) (PMMA). In other embodiments the first polymer is styrene-acrylonitrile (SAN) and the second polymer is a poly(phenylene oxide) (PPO); while in other embodiments the second polymer is styrene-acrylonitrile (SAN) and the first polymer is a poly(phenylene oxide) (PPO). In other embodiments the first polymer is styrene-acrylonitrile (SAN) and the second polymer is a polystyrene (PS); while in other embodiments the second polymer is styrene-acrylonitrile (SAN) and the first polymer is a polystyrene (PS).

In some embodiments the first and second polymers are both an acrylonitrile-styrene-acrylate (ASA). For example, the first and second polymer may be the same acrylonitrile-styrene-acrylate (ASA).

In some embodiments the first and second polymers are both a styrene-acrylate (NAS). For example, the first and second polymer may be the same styrene-acrylate (NAS).

In some embodiments the first and second polymers are both an SAN-NAS-ASA alloy. For example, the first and second polymer may be the same SAN-NAS-ASA alloy. In other embodiments the first polymer is an SAN-NAS-ASA alloy and the second polymer is a poly(phenylene oxide) (PPO); while in other embodiments the second polymer is an SAN-NAS-ASA alloy and the first polymer is a poly(phenylene oxide) (PPO). In other embodiments the first polymer is an SAN-NAS-ASA alloy and the second polymer is a polystyrene (PS); while in other embodiments the second polymer is an SAN-NAS-ASA alloy and the first polymer is a polystyrene (PS).

In some embodiments the first and second polymers are both a PBT/PC alloy. For example, the first and second polymer may be the same PBT/PC alloy. In other embodiments the first polymer is a PBT/PC alloy and the second polymer is a polybutylene terephthalate (PBT); while in other embodiments the second polymer is a PBT/PC alloy and the first polymer is a polybutylene terephthalate (PBT). In other embodiments the first polymer is a PBT/PC alloy and the second polymer is an ABS/PC alloy; while in other embodiments the second polymer is a PBT/PC alloy and the first polymer is an ABS/PC alloy. In other embodiments the first polymer is a PBT/PC alloy and the second polymer is a poly(methyl methacrylate) (PMMA); while in other embodiments the second polymer is a PBT/PC alloy and the first polymer is a poly(methyl methacrylate) (PMMA).

In some embodiments the first and second polymers are both a poly(phenylene oxide) (PPO). For example, the first and second polymer may be the same poly(phenylene oxide) (PPO).

In other embodiments each of the first and second polymers is selected from a polyolefin, a polyamide (PA), a polyoxymethylene (POM), a polybutylene terephthalate (PBT), a polyethylene tetraphthalate (PET), a polyether ether ketone (PEEK), a polyphenylene sulfide (PPS), a polysaccharide, a cellulosic polymer, a fluoropolymer, or a liquid crystal polymer (LCP). In some embodiments each of these first and second polymers are semi-crystalline polymers.

In some embodiments each of the first and second polymers is a polyolefin. For example, each of the first and second polymers may be a semi-crystalline polyolefin. In some embodiments the first and second polymers are the same polyolefin—including, for example, wherein the first and second polymer are the same semi-crystalline polyolefin.

In some embodiments each of the first and second polymers is a polyamide (PA). For example, each of the first and second polymers may be a semi-crystalline polyamide (PA). In some embodiments the first and second polymers are the same polyamide (PA)—including, for example, wherein the first and second polymer are the same semi-crystalline polyamide (PA).

In some embodiments each of the first and second polymers is a polyoxymethylene (POM). For example, each of the first and second polymers may be a semi-crystalline polyoxymethylene (POM). In some embodiments the first and second polymers are the same polyoxymethylene (POM)—including, for example, wherein the first and second polymer are the same semi-crystalline polyoxymethylene (POM).

In some embodiments each of the first and second polymers is a polybutylene terephthalate (PBT). For example, each of the first and second polymers may be a semi-crystalline polybutylene terephthalate (PBT). In some embodiments the first and second polymers are the same polybutylene terephthalate (PBT)—including, for example, wherein the first and second polymer are the same semi-crystalline polybutylene terephthalate (PBT).

In some embodiments each of the first and second polymers is a polyethylene tetraphthalate (PET). For example, each of the first and second polymers may be a semi-crystalline polyethylene tetraphthalate (PET). In some embodiments the first and second polymers are the same polyethylene tetraphthalate (PET)—including, for example, wherein the first and second polymer are the same semi-crystalline polyethylene tetraphthalate (PET).

In some embodiments each of the first and second polymers is a polyether ether ketone (PEEK). For example, each of the first and second polymers may be a semi-crystalline polyether ether ketone (PEEK). In some embodiments the first and second polymers are the same polyether ether ketone (PEEK)—including, for example, wherein the first and second polymer are the same semi-crystalline polyether ether ketone (PEEK).

In some embodiments each of the first and second polymers is a polyphenylene sulfide (PPS). For example, each of the first and second polymers may be a semi-crystalline polyphenylene sulfide (PPS). In some embodiments the first and second polymers are the same polyphenylene sulfide (PPS)—including, for example, wherein the first and second polymer are the same semi-crystalline polyphenylene sulfide (PPS).

In some embodiments each of the first and second polymers is a cellulosic polymer. For example, each of the first and second polymers may be a semi-crystalline cellulosic polymer. In some embodiments the first and second polymers are the same cellulosic polymer—including, for example, wherein the first and second polymer are the same semi-crystalline cellulosic polymer.

In some embodiments each of the first and second polymers is a fluoropolymer. For example, each of the first and second polymers may be a semi-crystalline fluoropolymer. In some embodiments the first and second polymers are the same fluoropolymer—including, for example, wherein the first and second polymer are the same semi-crystalline fluoropolymer.

In some embodiments each of the first and second polymers is a liquid crystal polymer (LCP). For example, each of the first and second polymers may be a semi-crystalline liquid crystal polymer (LCP). In some embodiments the first and second polymers are the same liquid crystal polymer (LCP)—including, for example, wherein the first and second polymer are the same semi-crystalline liquid crystal polymer (LCP).

In other embodiments each of the first and second polymers is selected from a polyethylene, a polypropylene, a polybutylene, a polymethylpentene, or a poly(vinyl cyclohexane). In some embodiments each of these first and second polymers are semi-crystalline polymers.

In some embodiments each of the first and second polymers is a polyethylene. For example, each of the first and second polymers may be a semi-crystalline polyethylene. In some embodiments the first and second polymers are the same polyethylene—including, for example, wherein the first and second polymer are the same semi-crystalline polyethylene.

In some embodiments each of the first and second polymers is a polypropylene. For example, each of the first and second polymers may be a semi-crystalline polypropylene. In some embodiments the first and second polymers are the same polypropylene—including, for example, wherein the first and second polymer are the same semi-crystalline polypropylene.

In some embodiments each of the first and second polymers is selected from an atactic polypropylene, an isotactic polypropylene, a syndiotactic polypropylene, or a polypropylene copolymer. In some embodiments each of these first and second polymers are semi-crystalline polymers.

In some embodiments each of the first and second polymers is an atactic polypropylene. For example, each of the first and second polymers may be a semi-crystalline atactic polypropylene. In some embodiments the first and second polymers are the same atactic polypropylene—including, for example, wherein the first and second polymer are the same semi-crystalline atactic polypropylene.

In some embodiments each of the first and second polymers is an isotactic polypropylene. For example, each of the first and second polymers may be a semi-crystalline isotactic polypropylene. In some embodiments the first and second polymers are the same isotactic polypropylene—including, for example, wherein the first and second polymer are the same semi-crystalline isotactic polypropylene.

In some embodiments each of the first and second polymers is a syndiotactic polypropylene. For example, each of the first and second polymers may be a semi-crystalline syndiotactic polypropylene. In some embodiments the first and second polymers are the same syndiotactic polypropylene—including, for example, wherein the first and second polymer are the same semi-crystalline syndiotactic polypropylene.

In some embodiments each of the first and second polymers is a polypropylene copolymer. For example, each of the first and second polymers may be a semi-crystalline polypropylene copolymer. In some embodiments the first and second polymers are the same polypropylene copolymer—including, for example, wherein the first and second polymer are the same semi-crystalline polypropylene copolymer.

In some embodiments each of the first and second polymers is a polybutylene. For example, each of the first and second polymers may be a semi-crystalline polybutylene. In some embodiments the first and second polymers are the same polybutylene—including, for example, wherein the first and second polymer are the same semi-crystalline polybutylene.

In some embodiments each of the first and second polymers is a polymethylpentene. For example, each of the first and second polymers may be a semi-crystalline polymethylpentene. In some embodiments the first and second polymers are the same polymethylpentene—including, for example, wherein the first and second polymer are the same semi-crystalline polymethylpentene.

In some embodiments each of the first and second polymers is poly(vinyl cyclohexane). For example, each of the first and second polymers may be a semi-crystalline poly(vinyl cyclohexane). In some embodiments the first and second polymers are the same poly(vinyl cyclohexane)—including, for example, wherein the first and second polymer are the same semi-crystalline poly(vinyl cyclohexane).

In some embodiments the polymers of the closure substrate and the label substrate are selected such that the resulting bonded articles are suitable for recycling without the need for the closure and label components to be detached.

In some embodiments the melting point of the first polymer is within 50 °C of the melting point of the second polymer. For example, in some embodiments the melting point of the first polymer is within 45 °C, or within 40 °C, or within 35 °C, or within 30 °C or within 25 °C, or within 20 °C, or within 15 °C, or within 10 °C, or within 5 °C, or within 3 °C, or within 2 °C, or within 1 °C, or within 0.5 °C, of the melting point of the second polymer. In other embodiments, the melting point of the first polymer is the same as the melting point of the second polymer, for example, wherein the first polymer is the same as the second polymer.

In some embodiments the melt flow rates of the first and second polymers are within 10 g/10 min of one another. For example, in some embodiments the melt flow rates of the first and second polymer are within 5 g/10 min, or within 3 g/10 min, or within 2 g/10 min, or within 1 g/10 min, or within 0.5 g/10 min, of one another. In other embodiments, the melt flow rate of the first polymer is the same as the melt flow rate of the second polymer, for example, wherein the first polymer is the same as the second polymer.

In some embodiments the melt flow rate of the closure substrate is less than about 10 g/10 min, and the melt flow rates of the first and second polymers are within 5 g/10 min of one another. For example, the melt flow rate of the closure substrate may range from about 1 g/10 min to about 8 g/10 min, or from about 1 g/10 min to about 6 g/10 min, or from about 1 g/10 min to about 5 g/10 min, or from about 1 g/10 min to about 4 g/10 min, and the melt flow rates of the first and second polymers are within 5 g/10 min of one another.

As illustrated in FIG. 5, which depicts a side view of the bonded article 120 along the plane P2 of FIG. 4, the label substrate 122 is in the form of a sheet having a thickness T_{L} and the closure substrate 124 is in the form of a flat plastic body having a thickness T_{C} that is greater than the thickness T_{L} of the label substrate 122. In some embodiments, the thickness T_{L} of the label substrate 122 is less than about 0.02 inch, and the thickness T_{C} of the closure substrate 124 is at least 1.5 times greater than the thickness T_{L} of the label substrate 122. In some embodiments the closure substrate 124 has an elongation at break of 25% or less.

As shown in FIG. 5, the bonding region 126 comprises a portion of the label substrate 122 laterally bound to a portion of the closure substrate 124, wherein the portion of the label substrate has a plurality of protrusions 128 extending outwardly from a first conjoined surface 130, and the portion of the closure substrate has a plurality of complementary depressions 132 extending inwardly from a second conjoined surface 134 that faces the first conjoined surface 130, wherein at least one protrusion 128 on the first conjoined surface 130 of the label substrate 122 bonds to at least one complementary depression 132 on the second conjoined surface 134 of the closure substrate 124.

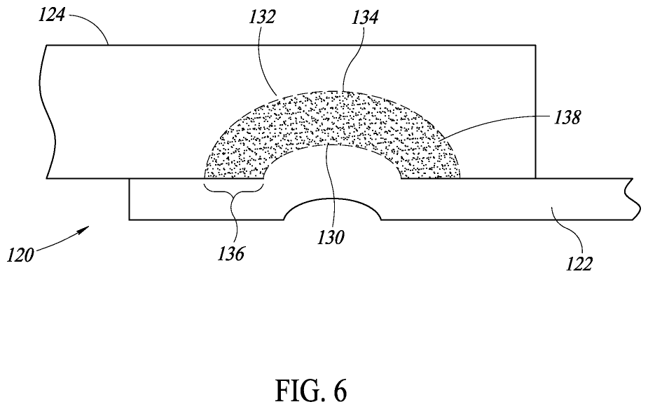

In some embodiments the protrusions 128 and/or the complementary depressions 132 may include a mixture of material from the label substrate 122 and material from the closure substrate 124. For example, as illustrated in FIG. 6, in some embodiments the bonding region 126 may include an interface region 136 containing a mixture of blended material 138 from the label and closure substrates.

In some embodiments the bonding region bonds the label substrate to the closure substrate with a lap shear strength of at least 75 N. For example, the lap shear strength may be at least 85 N, or at least 90 N, or at least 95 N, or at least 100 N, or at least 105 N, or at least 110 N, or at least 115 N, or at least 120 N, or at least 125 N, or at least 130 N, or at least 135 N, or at least 140 N, or at least 150 N, or at least 155 N, or at least 160 N.

In some embodiments the closure substrate also contains at least one filler. For example, the closure substrate may comprise at least one mineral filler. Mineral fillers contained in the closure substrate may be selected from calcium carbonate, calcium sulfate, dolomite, magnesium carbonate, barium carbonate, barium sulfate, aluminum oxide, aluminum hydroxide, calcium hydroxide, magnesium hydroxide, zinc hydroxide, kaolin, talc, mica, zinc oxide, zinc stearate, titanium oxide, silica, bentonite, glass fiber, diatomaceous earth, calcium sulfate, a smectite, a zeolite, quartz, and combinations thereof. In some embodiments the closure substrate may contain at least one organic filler. For example, organic fillers contained in the closure substrate may be selected from a carbon fiber, a plant fiber, an organic polymer, a lignin, a polysaccharide, and combinations thereof. The closure substrate may contain at least one mineral filler, at least one organic filler, and combinations thereof.

A proportion of the filler or fillers contained in the closure substrate may range from about 1 percent by weight to about 75 percent by weight relative to a total weight of the closure substrate. For example, the proportion of the at least one filler in the closure substrate can range from about 2 percent by weight to about 70 percent by weight, or from about 10 percent by weight to about 65 percent by weight, or from about 25 percent by weight to about 60 percent by weight, or from about 30 percent by weight to about 55 percent by weight, relative to the total weight of the closure substrate.

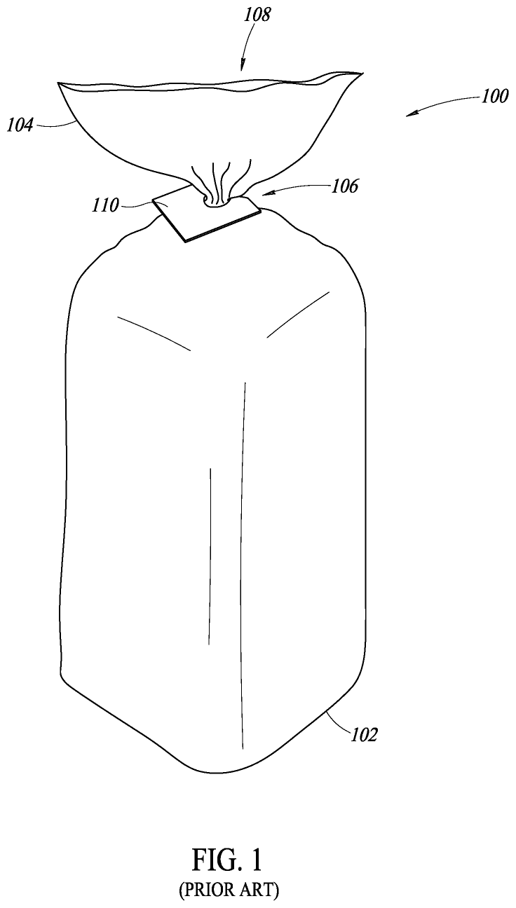

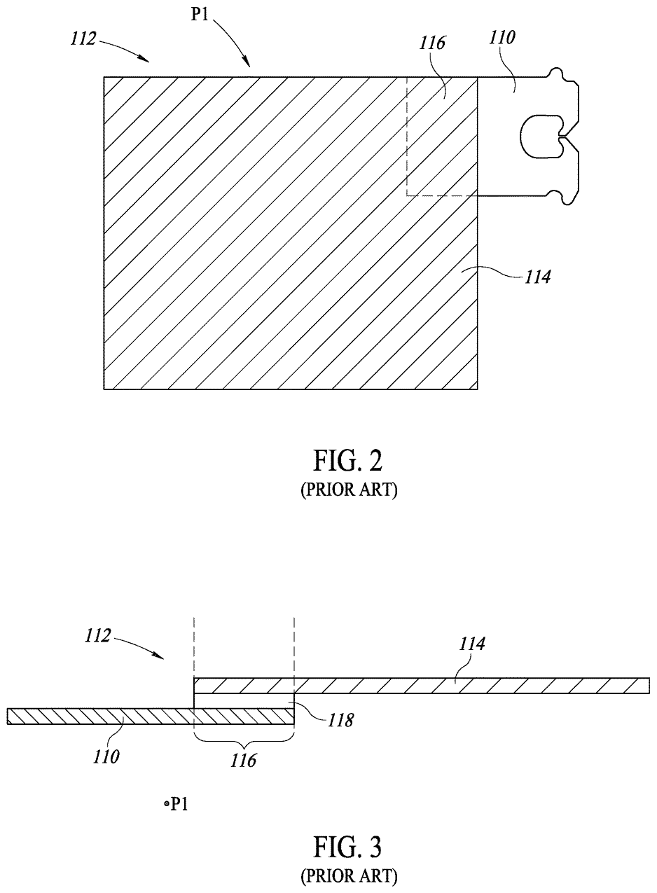

As explained above, the bonded articles of the present disclosure enable the production of packaging disclosures that can quickly and securely grip and hold the necks of flexible packages closed. In some embodiments, as illustrated in FIG. 4, the closure substrate 124 is in the form of a flat plastic body having an access opening 135 and a closure central aperture 140, such that the access opening 135 joins the closure central aperture 140 to define a continuous space. When functioning as a bag closure, the access opening 135 receives the neck of a flexible bag (see, e.g., neck 106 in FIG. 1), which is then held within the central aperture 140 in a closed condition. The central aperture 140 may have different shapes and features to accommodate different applications.

Closure substrates of the present disclosure may include a treated surface, such as treated surfaces that enable effective printing using various printing techniques. For example, in some embodiments the closure substrate has a corona treatment. In other embodiments the closure substrate may include a textured or roughened surface that enhances printability.

Closure substrates of the present disclosure can exhibit high durability and strength over a wide range of temperature, pressure, humidity and/or radiation exposure. To enable sufficient durability and strength, closure substrates of the present disclosure can be formulated and prepared to satisfy certain property requirements.

In some embodiments the closure substrate has a melting point ranging from about 110 °C to about 250 °C. For example, the melting point of the closure substrate may range from about 115 °C to about 230 °C, or from about 120 °C to about 220 °C, or from about 130 °C to about 200 °C, or from about 140 °C to about 190 °C, or from about 120 °C to about 180 °C, or from about 150 °C to about 175 °C.

In some embodiments the closure substrate has a density ranging from about 0.7 g/cm³ to about 2.2 g/cm³. For example, the density of the closure substrate may range from about 0.8 g/cm³ to about 1.6 g/cm³, or from about 0.9 g/cm³ to about 1.5 g/cm³, or from about 1.0 g/cm³ to about 1.4 g/cm³, or from about 1.1 g/cm³ to about 1.4 g/cm³, or from about 1.2 to about 1.3 g/cm³.

In some embodiments the closure substrate has a tensile strength ranging from about 10 MPa to about 40 MPa. For example, the tensile strength of the closure substrate may range from about 15 MPa to about 35 MPa; or from about 20 MPa to about 35 MPa, or from about 25 MPa to about 30 MPa. In some embodiments the closure substrate has a tensile strength ranging from about 15 MPa to about 20 MPa.

In some embodiments the closure substrate has a tensile modulus ranging from about 1000 MPa to about 4000 MPa. For example, the tensile modulus of the closure substrate may range from about 1500 MPa to about 3000 MPa, or from about 1700 MPa to about 2500 MPa, or from about 2400 MPa to about 3100 MPa, or from about 2100 MPa to about 2900 MPa. In some embodiments the closure substrate has a tensile modulus ranging from about 1650 MPa to about 2700 MPa, or from about 2640 MPa to about 2930 MPa.

In some embodiments the closure substrate has a flexural modulus ranging from about 1500 MPa to about 6000 MPa. For example, the flexural modulus of the closure substrate may range from about 2000 MPa to about 5000 MPa, or from about 2500 MPa to about 4500 MPa, or from about 3000 MPa to about 4000 MPa, or from about 3800 MPa to about 4200 MPa.

In some embodiments the closure substrate has an elongation at break of 30% or less. For example, the elongation at break of the closure substrate may be 25% or less, or 20% or less, or 15% or less, or 10% or less, or 5% or less. The elongation at break of the closure substrate may range from about 1% to about 30%, or from about 1% to about 20%, or from about 2% to about 15%, or from about 2% to about 6%, or from about 12% to about 18%. In some embodiments the closure substrate has an elongation at break ranging from about 3% to about 6%, or from about 8% to about 22%.

In some embodiments the closure substrate has an impact strength ranging from about 5 J/m to about 25 J/m. For example, the impact strength of the closure substrate may range from about 8 J/m to about 22 J/m, or from about, or from about 10 J/m to about 20 J/m, or from about 12 J/m to about 17 J/m, or from about 16 J/m to about 21 J/m. In some embodiments the closure substrate has an impact strength ranging from about 12 J/m to about 21 J/m.

In some embodiments the closure substrate has an Izod impact strength ranging from about 5 J/m to about 45 J/m (notched), and from about 75 J/m to about 300 J/m (unnotched). For example, the Izod impact strength (notched) of the closure substrate may range from about 10 J/m to about 40 J/m, or from about 15 J/m to about 30 J/m, or from about 20 J/m to about 25 J/m. For example, the Izod impact strength (unnotched) of the closure substrate may range from about 100 J/m to about 250 J/m, or from about 150 J/m to about 220 J/m, or from about 170 J/m to about 200 J/m.

In some embodiments the closure substrate has a Shore D hardness ranging from about 30 to about 120, and a Rockwell R hardness ranging from about 50 to about 150. For example, the Shore D hardness of the closure substrate may range from about 40 to about 100, or from about 50 to about 90, or from about 60 to about 80. For example, the Rockwell R hardness of the closure substrate may range from about 60 to about 130, or from about 80 to about 120, or from about 90 to about 110.

In some embodiments, the thickness T_{C} of the closure substrate may range from about 0.005 inch to about 0.2 inch. For example, the thickness T_{C} of the closure substrate may range from 0.005 inch to about 0.15 inch, or from about 0.01 inch to about 0.1 inch, or from about 0.015 inch to about 0.09 inch, or from about 0.02 inch to about 0.08 inch, or from about 0.03 inch to about 0.06 inch.

In some embodiments the thickness T_{C} of the closure substrate is at least 1.5 times greater than the thickness T_{L} of the label substrate. For example, the thickness T_{C} of the closure substrate may be at least 2.5 times greater, or at least 3.0 times greater, or at least 3.5 times greater, or at least 4.0 times greater, or at least 5 times greater, or at least 6 times greater, or at least 7.5 times greater, or at least 10 times greater, than the thickness T_{L} of the label substrate.

In some embodiments the thickness T_{L} of the label substrate is less than about 0.15 inch. For example, the thickness T_{L} of the label substrate may be less than about 0.12 inch, or less than about 0.10 inch, or less than about 0.08 inch, or less than about 0.06 inch, or less than about 0.05 inch, or less than about 0.04 inch, or less than about 0.03 inch, or less than about 0.02 inch, or less than about 0.01 inch, or less than about 0.005 inch, or less than about 0.003 inch. The thickness T_{L} of the label substrate may range from about 0.005 inch to about 0.15 inch, or from about 0.01 inch to about 0.14 inch, from about 0.04 inch to less than about 0.13 inch, or from about 0.08 inch to about 0.12 inch, or from about 0.01 inch to about 0.10 inch, or from about 0.02 inch to about 0.10 inch.

Label substrates of the present disclosure may include a treated surface, such as treated surfaces that enable effective printing using various printing techniques. For example, in some embodiments the label substrate has a corona treatment. In other embodiments the label substrate may include a textured or roughened surface that enhances printability. In some embodiments the label substrate may be a scored label substrate that facilitates removal of the label substrate from the closure substrate.

In some embodiments the surface energy of the label substrate ranges from about 20 dyne to about 50 dyne. For example, the label substrate may have a surface energy from about 25 dyne to about 50 dyne, or from about 30 dyne to about 45 dyne, or from about 32 dyne to about 40 dyne.

In some embodiments the label substrate also contains at least one filler. For example, the label substrate may comprise at least one mineral filler. Mineral fillers contained in the label substrate may be selected from calcium carbonate, calcium sulfate, dolomite, magnesium carbonate, barium carbonate, barium sulfate, aluminum oxide, aluminum hydroxide, calcium hydroxide, magnesium hydroxide, zinc hydroxide, kaolin, talc, mica, zinc oxide, zinc stearate, titanium oxide, silica, bentonite, glass fiber, diatomaceous earth, calcium sulfate, a smectite, a zeolite, quartz, and combinations thereof. In some embodiments the label substrate may contain at least one organic filler. For example, organic fillers contained in the label substrate may be selected from a carbon fiber, a plant fiber, an organic polymer, a lignin, a polysaccharide, and combinations thereof. The label substrate may contain at least one mineral filler, at least one organic filler, and combinations thereof.

A proportion of the filler or fillers contained in the label substrate may range from about 1 percent by weight to about 75 percent by weight relative to a total weight of the closure substrate. For example, the proportion of the at least one filler in the label substrate can range from about 2 percent be weight to about 70 percent by weight, or from about 10 percent by weight to about 60 percent by weight, or from about 20 percent by weight to about 55 percent by weight, or from about 25 percent by weight to about 50 percent by weight, relative to the total weight of the label substrate.

Label substrates of the present disclosure can exhibit high durability and strength over a wide range of temperature, pressure, humidity and/or radiation exposure. To enable sufficient durability and strength characteristics, label substrates of the present disclosure can be formulated and prepared to satisfy certain property requirements.

In some embodiments the label substrate has a melting point ranging from about 110 °C to about 250 °C. For example, the melting point of the label substrate may range from about 115 °C to about 200 °C, or from about 120 °C to about 180 °C, or from about 130 °C to about 170 °C, or from about 140 °C to about 160 °C.

In some embodiments the label substrate has a density ranging from about 0.7 g/cm³ to about 2.2 g/cm³. For example, the density of the label substrate may range from about 0.8 g/cm³ to about 1.6 g/cm³, or from about 0.8 g/cm³ to about 1.2 g/cm³, or from about 0.9 g/cm³ to about 1.5 g/cm³, or from about 1.0 g/cm³ to about 1.4 g/cm³, or from about 1.1 g/cm³ to about 1.3 g/cm³. In some embodiments the density of the label substrate is lower than a density of the closure substrate.

In some embodiments the label substrate has a tensile strength ranging from about 5 MPa to about 60 MPa. For example, the tensile strength of the label substrate may range from about 10 MPa to about 50 MPa, or from about 15 MPa to about 35 MPa; or from about 20 MPa to about 30 MPa, or from about 23 MPa to about 28 MPa.

In some embodiments the label substrate has a tensile modulus ranging from about 700 MPa to about 2000 MPa. For example, the tensile modulus of the label substrate may range from about 750 MPa to about 1800 MPa, or from about 800 MPa to 1500 MPa, or from about 900 MPa to about 1300 MPa, or from about 1000 MPa to about 1200 MPa.

In some embodiments the label substrate has a flexural modulus ranging from about 500 MPa to about 6000 MPa. For example, the flexural modulus of the label substrate may range from about 1000 MPa to about 5000 MPa, or from about 2000 MPa to about 4000 MPa, or from about 3000 MPa to about 5000 MPa, or from about 2500 MPa to about 4500 MPa.

In some embodiments the label substrate has an elongation at break ranging from about 5% to about 800%. For example, the elongation at break of the label substrate may range from about 10% to about 700%, or from about 50% to about 600%, or from about 100% to about 550%, or from about 200% to about 500%, or from about 300% to about 600%, or from about 400% to about 500%.

In some embodiments the label substrate has an impact strength ranging from about 5 J/m to about 25 J/m. For example, the impact strength of the label substrate may range from about 8 J/m to about 22 J/m, or from about 10 J/m to about 20 J/m, or from about 12 J/m to about 17 J/m, or from about 16 J/m to about 21 J/m.

In some embodiments the label substrate has an Izod impact strength ranging from about 5 J/m to about 45 J/m (notched), and from about 75 J/m to about 300 J/m (unnotched). For example, the Izod impact strength (notched) of the label substrate may range from about 10 J/m to about 40 J/m, or from about 15 J/m to about 30 J/m, or from about 20 J/m to about 25 J/m. For example, the Izod impact strength (unnotched) of the label substrate may range from about 100 J/m to about 250 J/m, or from about 150 J/m to about 220 J/m, or from about 170 J/m to about 200 J/m.

In some embodiments the label substrate has a Shore D hardness ranging from about 30 to about 120, and a Rockwell R hardness ranging from about 50 to about 150. For example, the Shore D hardness of the label substrate may range from about 40 to about 100, or from about 50 to about 90, or from about 60 to about 80. For example, the Rockwell R hardness of the label substrate may range from about 60 to about 130, or from about 80 to about 120, or from about 90 to about 110.

As explained above by reference to FIG. 5, the bonding region 126 comprises a portion of the label substrate 122 laterally bound to a portion of the closure substrate 124, such that a plurality of protrusions 128 extend outwardly from a first conjoined surface 130, and a plurality of complementary depressions 132 extend inwardly from a second conjoined surface 134 that faces the first conjoined surface 130. At least one protrusion 128 on the first conjoined surface 130 of the label substrate 122 bonds to at least one complementary depression 132 on the second conjoined surface 134 of the closure substrate 124. The bonding of the label substrate to the closure substrate occurs, at least in part, by melt bonding.

In some embodiments, the conjoined surface of the label substrate is a textured surface comprising the at least one protrusion that bonds to the complementary depression of the closure substrate. For example, the textured surface may include a knurled surface, a surface having at least one geometric feature, a surface having at least one point feature, or combinations thereof.

In some embodiments the bonding region comprises a plurality of point bonds, each point bond including a protrusion of the label substrate that is bonded to a complementary depression of the closure substrate. Point bonds can have many different shapes including, for example, circular shaped point bonds, oval shaped point bonds and polygonyl shaped point bonds. The bonding region may include at least 2 point bonds. For example, in some embodiments the bonding region comprises from 10 to 50 point bonds.

In some embodiments the bonding region includes a pattern of bonds showing a printed word or object as viewed from above the plane of the label substrate. The pattern of bonds can be formed based on the relative spacing of the bonds in the bonding region, or can be formed based on a plurality of bonds having different shapes, or can be formed based on the plurality of bonds having protrusions with different depths into the closure substrate, or can be formed based on the label substrate and the closure substrate having different colors, or any combination thereof. In some embodiments the pattern of bonds shows a word or logo.

In some embodiments the bonding region bonds the label substrate to the closure substrate with a lap shear strength of at least 75 N as measured when the bonded article is at room temperature. For example, the lap shear strength may be at least 85 N, or at least 90 N, or at least 95 N, or at least 100 N, or at least 105 N, or at least 110 N, or at least 115 N, or at least 120 N, or at least 125 N, or at least 130 N, or at least 135 N, or at least 140 N, or at least 150 N, or at least 155 N, or at least 160 N, as measured when the bonded article is at room temperature. In some embodiments, the bonding region bonds the label substrate to the closure substrate with a lap shear strength ranging from about 80 N to about 180 N, or from about 90 N to about 170 N, or from about 100 N to about 160 N, or from about 110 N to about 150 N, or from about 120 N to about 140 N, as measured when the bonded article is at room temperature.

The lap shear strength can vary depending on the temperature of the bonded article. For example, in some embodiments the bonding region bonds the label substrate to the closure substrate with a lap shear strength of at least 115 N as measured when the bonded article is at a temperature of about −10 °C, or the bonding region bonds the label substrate to the closure substrate with a lap shear strength of at least 110 N as measured when the bonded article is at a temperature of about 100 °C, or the bonding region bonds the label substrate to the closure substrate with a lap shear strength of at least 100 N as measured within 30 seconds of removing the bonded article from a steam sterilization process conducted in an autoclave at a temperature of about 120 °C under a pressure of about 1 atm, or any combination thereof.

The surface area of the bonding region can range from about 0.05 in² to about 10.0 in². For example, the bonding region may have a surface area ranging from about 0.01 in² to about 5.0 in², or from about 0.02 in² to about 2.0 in², or from about 0.03 in² to about 1.0 in², or from about 0.05 in² to about 0.5 in², about 0.1 in² to about 5.0 in², or from about 0.1 in² to about 1.0 in², or from about 0.2 in² to about 0.8 in², or from about 0.3 in² to about 0.5 in.

### Methods for Preparing Bonded Articles

Bonded articles of the present disclosure can be formed by ultrasonic welding. Some embodiments relate to methods for preparing the bonded article in which the label substrate is first placed atop the closure substrate such that a lower flat portion of the label substrate contacts an upper flat portion of the closure substrate, in a manner such that the contacted lower and upper flat portions constitute an overlap region. Then, while applying a downward force from an ultrasonic sonotrode to an upper flat portion of the label substrate within the overlap region, ultrasonic energy is applied from the ultrasonic sonotrode to the upper flat portion of the label substrate, thereby causing a portion of the first polymer in the overlap region and a portion of the second polymer in the overlap region to bond together and form the bonding region of the bonded article. The ultrasonic energy produces friction leading to localized melting between the label substrate and the closure substrate. In some embodiments, as described above with respect to FIG. 6, the localized melting of the label and closure substrates leads to the formation of an interface region 136 containing a mixture of blended materials from both substrates.

In some embodiments the ultrasonic bonding step may be repeated at least once to further bond the label substrate to the closure substrate.

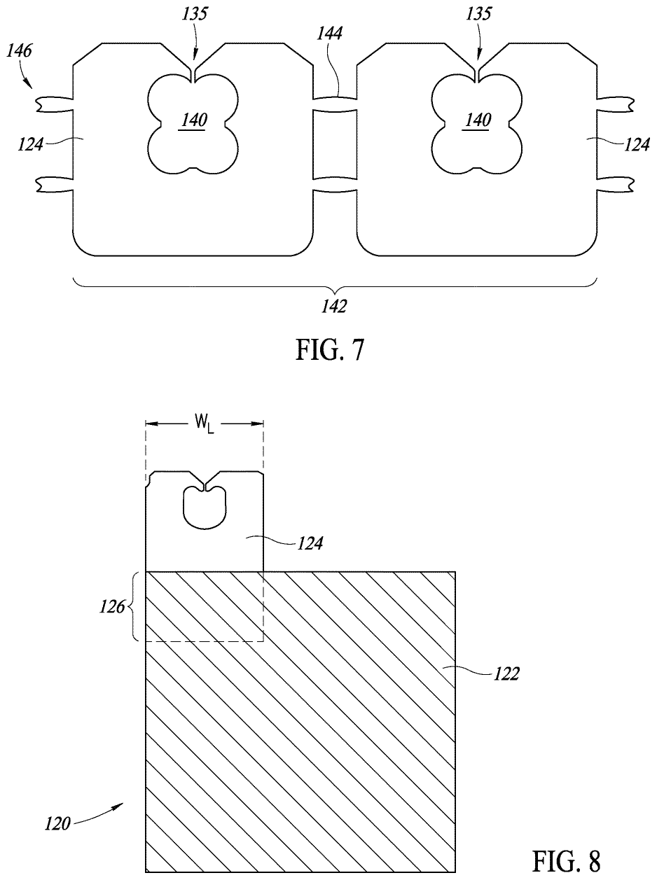

To enable high-throughput preparation of bonded articles, in some embodiments the closure substrate is in the form of a multi-closure strip allowing the ultrasonic bonding to occur in serial format at a high linear rate. For example, as illustrated in FIG. 7, in some embodiments the closure substrate is in the form of a multi-closure strip 142 comprising a plurality of connected closure substrates 124 that are linearly attached by one or more removable tabs 144. During the ultrasonic bonding process (either before, after or during the ultrasonic bonding) these removable tabs 144 can be broken off 146 to cause separation of the individual closure substrates 124 (or individual bonded articles 120) from one another. The removable tabs 144 may be in any configuration that can sustain the bonding process and be broken off when a specific force is applied. See, e.g., U.S. Pat. No. 4,333,566. In other embodiments the access opening 135 may be rotated 90 degrees (clockwise or counterclockwise) relative to the multi-closure strip 142 shown in FIG. 7.

As explained above, the use of a multi-closure strip enables the ultrasonic bonding process to occur in serial format at a high linear rate. In some embodiments a linear speed at which the label substrate is bonded to the closure substrate can range from about 0.2 foot/min to about 500 foot/min, as measured relative to a lateral width of the closure substrate. For example, the label substrate may be bonded to the closure substrate at a linear speed ranging from about 1 foot/min to about 200 foot/min, or from about 5 foot/min to about 100 foot/min, or from about 10 foot/min to about 80 foot/min, or from about 25 foot/min to about 75 foot/min, or from about 40 foot/min to about 65 foot/min, or from about 50 foot/min to about 60 foot/min.

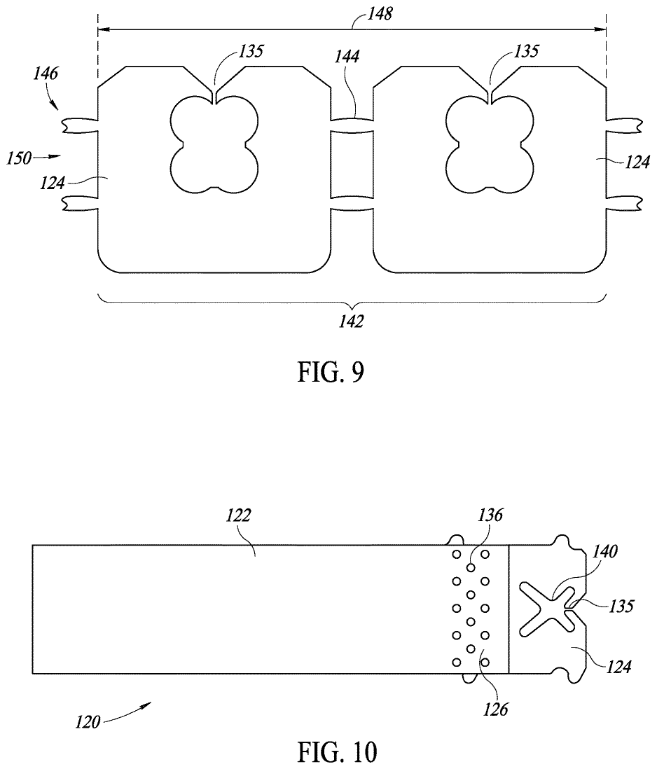

FIGS. 8 and 9 illustrate how the linear speed can be measured for embodiments of the present disclosure. The linear speed is generally based on the rate at which the bonding process occurs relative to a length of the bonding region that is produced. For example, as shown in FIG. 8, the linear speed can be based on the width of the closure substrate 124 that is bonded to the label substrate 122. The lateral width W_{L} can be measured based on the width of the closure substrate 124 (or the width of the bonding region 126) of the bonded article 120, even when the width of the label substrate 122 is greater than the width of the closure substrate 124, as illustrated for the bonded article 120 of FIG. 8. Thus, the linear speed can be based on lateral width W_{L} of the closure substrate 124 (or the bonding region 126) multiplied by the number of bonded articles 120 formed during a certain period of time.

Alternatively, as illustrated in FIG. 9, when a multi-closure strip 142 is used to prepare bonded articles in high-throughput fashion (150 indicating the direction of travel of the multi-closure strip 142 during the bonding process), the linear speed can be based on the linear length 148 of the multi-closure strip 142 (or a portion thereof as illustrated in FIG. 9). Thus, an average linear speed can be calculated based on the linear length 148 of the multi-closure strip 142 and the time required to complete the bonding process along the linear length 148. The linear length 148 of FIG. 9 is for illustration purposes only. In some embodiments the linear length relates to the total length of a multi-closure strip having hundreds or even thousands of individual closure substrates 124. In other embodiments, where the access opening 135 is rotated 90 degrees (clockwise or counterclockwise) relative to the multi-closure strip 142 shown in FIG. 9, the linear speed may be calculated based on the distance between the removable tabs 144. In some embodiments, the ultrasonic bonding is carried out using a plurality to ultrasonic sonotrodes, wherein the plurality of ultrasonic sonotrodes can be used to simultaneously produce different bonded articles (e.g., parallel production of bonded articles using more than one sonotrode), or can be used to perform separate bonding steps on each bonded article (e.g., using a plurality of serially-placed sonotrodes to produce a bonding region having a pattern of bonds showing a printed word or object such as a logo).

In some embodiments an incident angle of the ultrasonic sonotrode during the bonding process is about 0 degrees, as measured from the normal of the upper flat portion of the label substrate. In some embodiments the incident angle ranges from 0 to 5 degrees, or from 0 to 2 degrees, or from 0 to 2 degrees. In some embodiments the incident angle is set at 0 degrees.

In some embodiments the bonding time during which the downward force and ultrasonic energy are applied to the upper flat portion of the label substrate can be altered to change the characteristics of the bonding region. The bonding time can range from about 1 ms to about 500 ms. For example, the bonding time may range from about 5 ms to about 300 ms, or from about 10 ms to about 200 ms, or from about 10 ms to about 200 ms, or from about 20 ms to about 100 ms, or from about 30 ms to about 80 ms, or from about 40 ms to about 60 ms.

The downward force applied to the upper flat portion of the label substrate can be altered to change the characteristics of the bonding region. The downward force applied to the upper flat portion of the label substrate can independently range from about 50 N to about 800 N. For example, the downward force may range from about 200 N to about 700 N, or from about 300 N to about 600 N, or from about 400 N to about 500 N.

The ultrasonic frequency of the ultrasonic energy applied by the ultrasonic sonotrode can be altered to change the characteristics of the resulting bonding region. The frequency of the ultrasonic energy from the ultrasonic sonotrode may range from about 5 kHz to about 100 kHz. For example, the frequency of the ultrasonic energy may range from about 10 kHz to about 50 kHz, or from about 20 kHz to about 40 kHz, or from about 25 kHz to about 35 kHz.

The power level of the ultrasonic energy applied by the ultrasonic sonotrode can be altered to change the characteristics of the bonding region. The power level of the ultrasonic energy may range from about 50 W to about 3000 W. For example, the power level of the ultrasonic energy may range from about 100 W to about 2000 W, or from about 200 W to about 1500 W, or from about 400 W to about 1000 W, or from about 500 W to about 800 W.

The ultrasonic energy may be applied in different orientations to change the characteristics of the bonding region. In some embodiments the ultrasonic energy is applied as longitudinal ultrasonic energy, while in other embodiments the ultrasonic energy is applied as torsional ultrasonic energy.

Ultrasonic sonotrodes used in the methods of the present disclosure may include a plurality of pins having different shapes. For example, ultrasonic sonotrodes of the present disclosure may include circular shaped pins, oval shaped pins, polygonyl shaped pins, or any combination thereof. In some embodiments all of the pins on the output tip of the ultrasonic sonotrode may having the same shape, such as circular-shaped pins.

The output tip of the ultrasonic sonotrode generally includes at least 2 pins. For example, the output tip of the ultrasonic sonotrode may contain from 2 pins to 100 pins, or from 5 pins to 80 pins, or from 10 pins to 50 pins. The height of the pins on the output tip of the ultrasonic sonotrode can independently range from about 0.002 inch to about 0.2 inch. For example, the ultrasonic sonotrode may include a plurality of pins having heights independently ranging from about 0.005 inch to about 0.15 inch, or from about 0.008 inch to about 0.10 inch, or from about 0.01 inch to about 0.08 inch. In some embodiments the output tip of the ultrasonic sonotrode may include a plurality of pins have different heights enabling the fine tuning of the bonding region or enabling the bonding region to include a pattern of bonds showing a printed word or object.

Ultrasonic sonotrodes used in methods of the present disclosure can be composed of various materials. In some embodiments the ultrasonic sonotrode is constructed of at least one metal selected from aluminum, steel, titanium and alloys thereof. In some embodiments the ultrasonic sonotrode is a treated ultrasonic sonotrode having increased lifespan compared to an untreated ultrasonic sonotrode. For example, the ultrasonic sonotrode may be treated with a longevity treatment such as a heat treatment, a surface treatment, or a combination thereof. Longevity treatments may include electroless nickel surface treatments, a carbide surface treatments, or combinations thereof.

In some embodiments an output tip of the ultrasonic sonotrode has a textured surface. For example, the output tip of the ultrasonic sonotrode may have a textured surface with a knurled surface, a surface having at least one geometric feature, a surface having at least one point feature, or any combination thereof.

The disclosure is illustrated by the following examples, which are not intended to be limiting.

### EXAMPLES

### Materials and Instruments

A mineral-filled polypropylene is used to prepare the closure substrates described in the examples below. The mineral-filled polypropylene contains approximately 40% by weight talc as determined by TGA/FTIR (thermogravimetric analysis—Fourier transform infrared spectroscopy), and is tested using the standard methodologies described above and is found to have a tensile strength of 18.3±0.9 MPa, a tensile modulus of 2787±140 MPa, an elongation at break of 4.1±1.0%, and an impact strength of 18.3±2.4 J/m. Closure substrates (depicted as item 124 in FIGS. 10-12) having a thickness of 0.03 inch are used in the examples below.

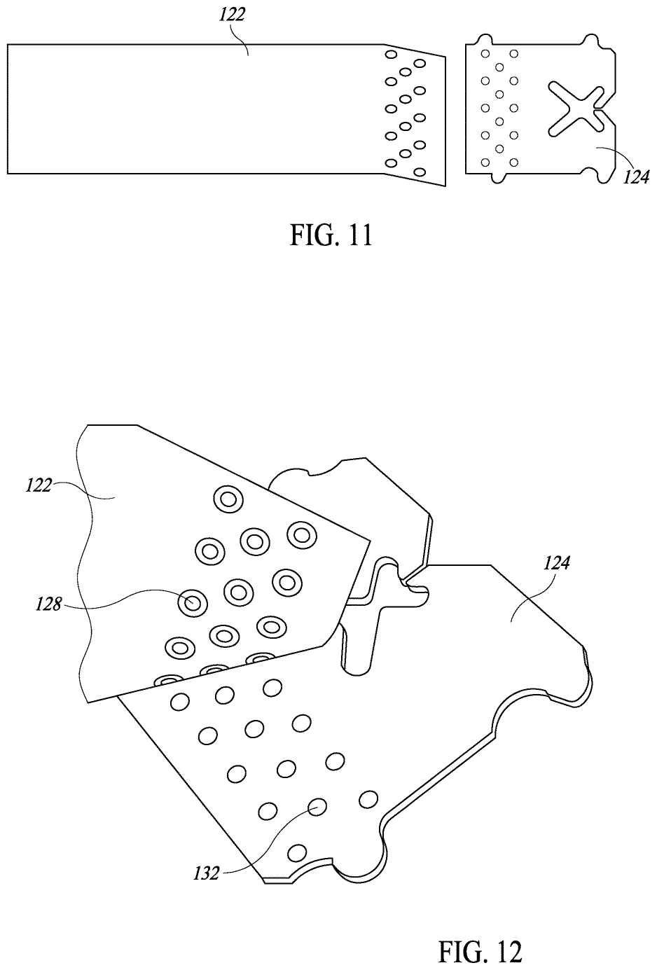

A polypropylene film is used to prepare the label substrates described in the examples below. The polypropylene film is tested using the standard methodologies described above and is found to have a tensile strength of 26 MPa, a tensile modulus of 1130 MPa, and an elongation at break of 470%. Label substrates (depicted as item 122 in FIGS. 10 and 11) having a thickness of 0.01 inch are cut from sheets of the polypropylene film.

Ultrasonic bonding is performed using a commercial ultrasonic generator having a maximum output of 1200 W at 35 kHz, with a commercial 35 kHz booster, and ultrasonic horn (sonotrode) having twenty (20) 0.060 inch tall radiused pins (whose pattern is depicted in the bonding region 126 of FIG. 10). Bonding experiments are performed at 100% amplitude.

### Comparative Example 1

(Bonding with Only Commercial Adhesive)

A comparative bonded article is prepared by applying a commercial hot melt adhesive to a portion of one face of the closure substrate, and the label substrate is then placed on top of a closure substrate such that an overlap region is formed in which the hot melt adhesive is sandwiched between the closure substrate and the label substrate, see FIG. 3. The overlap region measures ⅞ inch by 5/16 inch. Then a force of 228.5 N is applied to the overlap region using a presser foot and a spring-loaded backing anvil, and the force is maintained for 10 millisecond (ms). After the 10 ms period under force, the force is released and the resulting adhesive bonded article is allowed to cool to room temperature before testing. Five (5) of the adhesive bonded articles are prepared using the same procedure.

The five (5) adhesive bonded articles are then conditioned in a controlled lab environment at 70-72 °F (21-22 °C) and 20-22% humidity for a 24-hour period prior to performing lap shear strength testing. Lap shear tests are performed on each of the adhesive bonded articles at room temperature using the standard methodology described above, and the measured lap shear strengths are found to have an average lap shear strength of 93±10 N.

### Example 1

(Bonding with Ultrasonic Energy) (Room Temperature Testing)

A label substrate is placed on top of a closure substrate, which is supported by a flat anvil, such that an overlap region covering a portion of the closure substrate is formed. The overlap region measures ⅞ inch by 5/16 inch. Then, using the ultrasonic bonding apparatus and the 20-pin sonotrode described above, a downward force of 400 N is applied from the output tip of the sonotrode to the upper flat portion of the label substrate within the overlap region, and longitudinal ultrasonic energy (1200 W at 35 kHz) is simultaneously applied to the upper flat portion of the label substrate within the overlap region for a period of 100 ms. After the ultrasonic bonding period, the force and ultrasonic energy are released and the resulting ultrasonic bonded article is allowed to stand at room temperature for at least 2 hours. Five (5) of the ultrasonic bonded articles are prepared using the same procedure.

FIG. 10 shows the ultrasonic bonded article 120 formed using the procedure above, wherein the label substrate 122 is bonded to the closure substrate 124 via a bonding region 126 having a pattern of twenty (20) point bonds.

The five (5) ultrasonic bonded articles are then conditioned in controlled lab environment at 70-72 °F (21-22 °C) and 20-22% humidity for a 24-hour period prior to performing lap shear strength testing. Lap shear tests are performed on each of the ultrasonic bonded articles at room temperature using the standard methodology described above, and the measured lap shear strengths are found to have an average lap shear strength of 133±2 N.

FIG. 11 shows the separated label substrate 122 and closure substrate 124 following the lap shear test. FIG. 12 shows the separated label substrate 122 and closure substrate 124 in reassembled form illustrating how each of the protrusions 128 on the formerly conjoined surface of the label substrate 122 correspond to complementary depressions 132 on the formerly conjoined surface of the closure substrate 124.

### Comparative Example 2

(Bonding with Adhesive and Ultrasonic Energy)

A comparative bonded article is prepared by applying a commercial hot melt adhesive to a portion of one face of the closure substrate, and then a label substrate is placed on top of the closure substrate, which is supported by a flat anvil, such that an overlap region is formed wherein the hot melt adhesive is sandwiched between the closure substrate and the label substrate. The overlap region measures ⅞ inch by 5/16 inch. Then, using the ultrasonic bonding apparatus and the 20-pin sonotrode described above, a downward force of 400 N is applied from the output tip of the sonotrode to the upper flat portion of the label substrate within the overlap region, and longitudinal ultrasonic energy (1200 W at 35 kHz) is simultaneously applied to the upper flat portion of the label substrate within the overlap region for a period of 20 ms. After the ultrasonic bonding period, the force is released and the resulting adhesive-ultrasonic bonded article is allowed to stand at room temperature for at least 2 hours. Five (5) of the adhesive-ultrasonic bonded articles are prepared using the same procedure.

The five (5) adhesive-ultrasonic bonded articles are then conditioned in a controlled lab environment at 70-72 °F (21-22 °C) and 20-22% humidity for a 24-hour period prior to performing lap shear strength testing. Lap shear tests are performed on each of the adhesive-ultrasonic bonded articles at room temperature using the standard methodology described above, and the bonded articles are found to have an average lap shear strength of 100±9 N.

### Example 2

(Bonding with Only Ultrasonic Energy) (Cold Temperature Testing)

A label substrate is placed on top of a closure substrate, which is supported by a flat anvil, such that an overlap region covering a portion of the closure substrate is formed. The overlap region measures ⅞ inch by 5/16 inch. Then, using the ultrasonic bonding apparatus and 20-pin sonotrode described above, a downward force of 400 N is applied from the output tip of the sonotrode to the upper flat portion of the label substrate within the overlap region, and longitudinal ultrasonic energy (1200 W at 35 kHz) is simultaneously applied to the upper flat portion of the label substrate within the overlap region for a period of 20 ms. After the ultrasonic bonding period, the force is released and the resulting ultrasonic bonded article is allowed to stand at room temperature for at least 2 hours. Five (5) of the ultrasonic bonded articles are prepared using the same procedure.

The five (5) ultrasonic bonded articles are then placed in a freezer at 12 °F (−11 °C) for at least 24 hours and lap shear tests are immediately performed on each of the cold adhesive bonded articles in a controlled lab environment at 70-72 °F (21-22 °C) and 20-22% humidity using the standard methodology described above, and the measured lap shear strengths are found to have an average lap shear strength of 118±8 N.

### Data Analysis

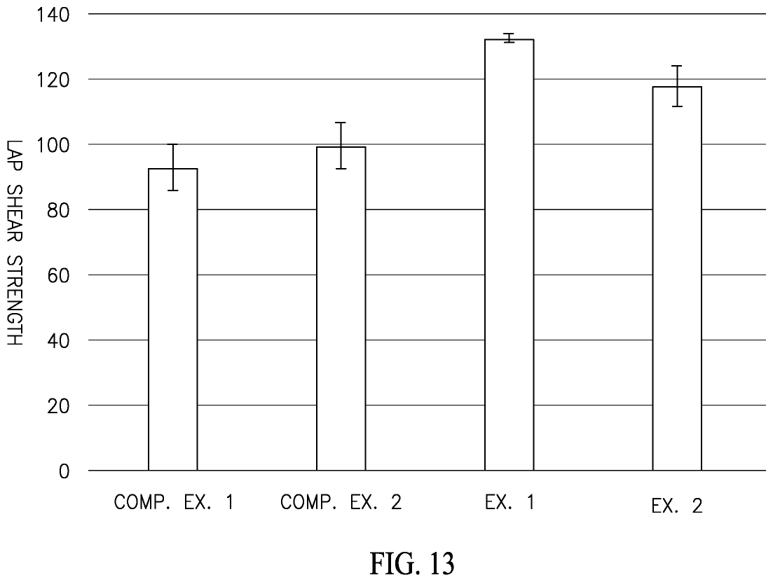

Table 1 below and the chart in FIG. 13 summarize the results of the examples described above.

TABLE 1

| Sample | Lap Shear Strength (N) |
|---|---|
| Comparative Example 1 | 93 ± 10 |
| Comparative Example 2 | 100 ± 9 |
| Example 1 | 133 ± 2 |
| Example 2 | 118 ± 8 |

These results demonstrate that an ultrasonic bonding method of the present disclosure can produce a bonded article (Ex. 1) having significantly increased lap shear strength compared to a bonded article (Comp. Ex. 1) formed using a commercial adhesive. A bonded article formed using both a commercial adhesive and ultrasonic bonding (Comp. Ex. 2) also has a lower lap shear strength compared to a bonding article formed by ultrasonic bonding (Example 1).

The data for Example 2 demonstrates that ultrasonic bonded articles can still maintain high lap shear strength even when cooled to freezer conditions.

As illustrated in Examples 1 and 2, even extremely thin (0.01 inch) polypropylene labels can be reliably bonded to polypropylene closures using an ultrasonic bonding method of the present disclosure to obtain high-strength packaging closures.

### EMBODIMENTS

Embodiment [1] of the present disclosure relates to a bonded article, comprising of a label substrate bonded to a closure substrate via a bonding region, wherein: the label substrate comprises a first polymer, and the closure substrate comprises a second polymer, wherein the first and second polymers are chemically compatible for ultrasonic bonding together; the label substrate is in the form of a sheet having a thickness of less than about 0.02 inch, and the closure substrate is in the form of a flat plastic body having a thickness at least 2.5 times greater than the thickness of the label substrate and having an elongation at break of 25% or less; the bonding region comprises a portion of the label substrate laterally bonded to a portion of the closure substrate, wherein the portion of the label substrate has a plurality of protrusions extending outwardly from a first conjoined surface, and the portion of the closure substrate has a plurality of complementary depressions extending inwardly from a second conjoined surface that faces the first conjoined surface, wherein at least one protrusion on the first conjoined surface of the label substrate bonds to at least one complementary depression on the second conjoined surface of the closure substrate; and the bonding region bonds the label substrate to the closure substrate with a lap shear strength of at least 100 N.

Embodiment [2] of the present disclosure relates to the bonded article according to Embodiment [1], wherein the first and second polymers are each independently an amorphous polymer or a semi-crystalline polymer.

Embodiment [3] of the present disclosure relates to the bonded article according to Embodiment [1] or [2], wherein the first and second polymers independently comprise at least one selected from the group consisting of a polyolefin, a polyacrylate, a polystyrene (PS), a styrene-butadiene (SB) polymer, a polyacrylonitrile (PAN), an acrylonitrile-butadiene-styrene (ABS) polymer, a polyacrylonitrile-ethylene-propylene-diene-styrene copolymer (A-EPDM), a polycarbonate (PC), an ABS/PC alloy, a polyester, a polyhydroxyalkanoate, a phenolic resin, a urea resin, a melamine resin, an alkyd resin, an epoxy resin, a polylactic acid (PLA), a polyurethane (PU), a polyether, a polyvinyl alcohol (PVA), a polyamide (PA), a polyetherimide (PEI), a polyethersulfone (PES), a polysulfone, a polyvinylchloride (PVC), a polyoxymethylene (POM), a styrene-acrylonitrile (SAN), an acrylonitrile-styrene-acrylate (ASA), a styrene-acrylate (NAS), a SAN-NAS-ASA alloy, a polybutylene terephthalate (PBT), a PBT/PC alloy, a polyethylene tetraphthalate (PET), a polyether ether ketone (PEEK), a poly(phenylene oxide) (PPO), a polyphenylene sulfide (PPS), a polysaccharide, a fluoropolymer, a liquid crystal polymer (LCP), and copolymers thereof.

Embodiment [4] of the present disclosure relates to the bonded article according any of Embodiments [1]-[3], wherein the first and second polymers independently comprise at least one selected from the group consisting of a polyacrylate, a polystyrene (PS), a styrene-butadiene (SB) polymer, an acrylonitrile-butadiene-styrene (ABS) polymer, a polycarbonate (PC), an ABS/PC alloy, a polyetherimide (PEI), a polyethersulfone (PES), a polysulfone, a polyvinylchloride (PVC), a styrene-acrylonitrile (SAN), an acrylonitrile-styrene-acrylate (ASA), a styrene-acrylate (NAS), a polysaccharide, a SAN-NAS-ASA alloy, a PBT/PC alloy, and a poly(phenylene oxide) (PPO).

Embodiment [5] of the present disclosure relates to the bonded article according any of Embodiments [1]-[4], wherein at least one of the first polymer and the second polymer, independently, further comprises at least one selected from the group consisting of a polyacrylonitrile (PAN), a polyacrylonitrile-ethylene-propylene-diene-styrene copolymer (A-EPDM), a polyester, a polyhydroxyalkanoate, a phenolic resin, a urea resin, a melamine resin, an alkyd resin, an epoxy resin, a polylactic acid (PLA), a polyurethane (PU), a polyether, and a polyvinyl alcohol (PVA).

Embodiment [6] of the present disclosure relates to the bonded article according any of Embodiments [1]-[5], wherein each of the first and second polymer are amorphous polymers.

Embodiment [7] of the present disclosure relates to the bonded article according any of Embodiments [1]-[6], wherein each of the first and second polymers is selected from the group consisting of a polyolefin, a polyamide (PA), a polyoxymethylene (POM), a polybutylene terephthalate (PBT), a polyethylene tetraphthalate (PET), a polyether ether ketone (PEEK), a polyphenylene sulfide (PPS), a polysaccharide, a cellulosic polymer, a fluoropolymer, and a liquid crystal polymer (LCP).

Embodiment [8] of the present disclosure relates to the bonded article according any of Embodiments [1]-[7], wherein each of the first and second polymers is a polyolefin.

Embodiment [9] of the present disclosure relates to the bonded article according any of Embodiments [1]-[8], wherein each of the first and second polymers is selected from the group consisting of a polyethylene, a polypropylene, a polybutylene, a polymethylpentene, and a poly(vinyl cyclohexane).

Embodiment [10] of the present disclosure relates to the bonded article according any of Embodiments [1]-[9], wherein each of the first and second polymers is a polypropylene.

Embodiment [11] of the present disclosure relates to the bonded article according any of Embodiments [1]-[10], wherein each of the first and second polymer is selected from the group consisting of an atactic polypropylene, an isotactic polypropylene, a syndiotactic polypropylene, and a polypropylene copolymer.

Embodiment [12] of the present disclosure relates to the bonded article according any of Embodiments [1]-[11], wherein each of the first and second polymers is a semi-crystalline polymer.

Embodiment [13] of the present disclosure relates to the bonded article according any of Embodiments [1]-[3], wherein the first and second polymers are the same polymer.

Embodiment [14] of the present disclosure relates to the article according to any of Embodiments [1]-[13], wherein the thickness of the closure substrate ranges from about 0.01 inch to about 0.1 inch.

Embodiment [15] of the present disclosure relates to the article according to any of Embodiments [1]-[14], wherein the flat plastic body has an access opening and a closure central aperture, such that the access opening joins the closure central aperture to define a continuous space.

Embodiment [16] of the present disclosure relates to the article according to any of Embodiments [1]-[15], wherein the closure substrate functions as a bag closure.

Embodiment [17] of the present disclosure relates to the article according to any of Embodiments [1]-[16], wherein the closure substrate includes a surface treated for printing.

Embodiment [18] of the present disclosure relates to the article according to any of Embodiments [1]-[17], wherein the closure substrate is a corona treated substrate.

Embodiment [19] of the present disclosure relates to the article according to any of Embodiments [1]-[18], wherein closure substrate further comprises at least one filler.

Embodiment [20] of the present disclosure relates to the article according to any of Embodiments [1]-[19], wherein the closure substrate further comprises at least one mineral filler.

Embodiment [21] of the present disclosure relates to the article according to any of Embodiments [1]-[20], wherein the closure substate further comprises at least one mineral filler selected from the group consisting of calcium carbonate, calcium sulfate, dolomite, magnesium carbonate, barium carbonate, barium sulfate, aluminum oxide, aluminum hydroxide, calcium hydroxide, magnesium hydroxide, zinc hydroxide, kaolin, talc, mica, zinc oxide, zinc stearate, titanium oxide, silica, bentonite, glass fiber, diatomaceous earth, calcium sulfate, a smectite, a zeolite, and quartz.

Embodiment [22] of the present disclosure relates to the article according to any of Embodiments [1]-[21], wherein the closure substrate further comprises at least one organic filler.

Embodiment [23] of the present disclosure relates to the article according to any of Embodiments [1]-[22], wherein the closure substrate further comprises at least one organic filler selected from the group consisting of a carbon fiber, a plant fiber, an organic polymer, a lignin, and a polysaccharide.

Embodiment [24] of the present disclosure relates to the article according to any of Embodiments [1]-[23], wherein a proportion of the at least one filler in the closure substrate ranges from about 2 percent by weight to about 70 percent by weight relative to a total weight of the closure substrate.

Embodiment [25] of the present disclosure relates to the article according to any of Embodiments [1]-[24], wherein the closure substrate satisfies at least one of the following properties: a melting point ranging from about 120 °C to about 180 °C; a density ranging from about 0.8 g/cm³ to about 1.6 g/cm³; a tensile strength ranging from about 15 MPa to about 35 MPa; a tensile modulus ranging from about 1500 MPa to about 3000 MPa; a flexural modulus ranging from about 2000 MPa to about 5000 MPa; an elongation at break ranging from about 1% to about 20%; an impact strength ranging from about 10 J/m to about 20 J/m; an Izod impact strength ranging from about 10 J/m to about 40 J/m (notched), and from about 100 J/m to about 250 J/m (unnotched); and a Shore D hardness ranging from about 40 to about 100, and a Rockwell R hardness ranging from about 60 to about 130.

Embodiment [26] of the present disclosure relates to the article according to any of Embodiments [1]-[25], wherein the thickness of the label substrate sheet ranges from about 0.005 inch to about 0.02 inch.

Embodiment [27] of the present disclosure relates to the article according to any of Embodiments [1]-[26], wherein the label substrate includes a surface treated for printing.

Embodiment [28] of the present disclosure relates to the article according to any of Embodiments [1]-[27], wherein the label substrate is a corona treated substrate.

Embodiment [29] of the present disclosure relates to the article according to any of Embodiments [1]-[28], wherein a surface energy of the label substrate ranges from about 25 dyne to about 45 dyne. (ASTM D 2578).

Embodiment [30] of the present disclosure relates to the article according to any of Embodiments [1]-[29], wherein label substrate further comprises at least one filler.

Embodiment [31] of the present disclosure relates to the article according to any of Embodiments [1]-[30], wherein the label substrate further comprises at least one mineral filler.

Embodiment [32] of the present disclosure relates to the article according to any of Embodiments [1]-[31], wherein the label substate further comprises at least one mineral filler selected from the group consisting of calcium carbonate, calcium sulfate, dolomite, magnesium carbonate, barium carbonate, barium sulfate, aluminum oxide, aluminum hydroxide, calcium hydroxide, magnesium hydroxide, zinc hydroxide, kaolin, talc, mica, zinc oxide, zinc stearate, titanium oxide, silica, bentonite, glass fiber, diatomaceous earth, calcium sulfate, a smectite, a zeolite, and quartz.

Embodiment [33] of the present disclosure relates to the article according to any of Embodiments [1]-[32], wherein the label substrate further comprises at least one organic filler.

Embodiment [34] of the present disclosure relates to the article according to any of Embodiments [1]-[33], wherein the label substrate further comprises at least one organic filler selected from the group consisting of a carbon fiber, a plant fiber, an organic polymer, a lignin, and a polysaccharide.

Embodiment [35] of the present disclosure relates to the article according to any of Embodiments [22]-[34], wherein a proportion of the at least one filler in the label substrate ranges from about 2 percent by weight to about 70 percent by weight relative to a total weight of the closure substrate.

Embodiment [36] of the present disclosure relates to the article according to any of Embodiments [1]-[35], wherein the label substrate satisfies at least one of the following properties: a melting point ranging from about 120 °C to about 180 °C; a density ranging from about 0.8 g/cm³ to about 1.6 g/cm³; a tensile strength ranging from about 15 MPa to about 35 MPa; a tensile modulus ranging from about 800 MPa to 1500 MPa; a flexural modulus ranging from about 1000 MPa to about 4000 MPa; an elongation at break ranging from about 10% to about 700%; an impact strength ranging from about 10 J/m to about 20 J/m; an Izod impact strength ranging from about 10 J/m to about 40 J/m (notched), and from about 100 J/m to about 250 J/m (unnotched); and a Shore D hardness ranging from about 40 to about 100, and a Rockwell R hardness ranging from about 60 to about 130.

Embodiment [37] of the present disclosure relates to the article according to any of Embodiments [1]-[36], wherein the bonding region bonds the label substrate to the closure substrate by melt bonding.

Embodiment [38] of the present disclosure relates to the article according to any of Embodiments [1]-[37], wherein the conjoined surface of the label substrate is a textured surface comprising the at least one protrusion that bonds to the complementary depression of the closure substrate.

Embodiment [39] of the present disclosure relates to the article according to Embodiment [38], wherein the textured surface comprises a knurled surface, a surface having at least one geometric feature, a surface having at least one point feature, or a combination thereof.

Embodiment [40] of the present disclosure relates to the article according to any of Embodiments [1]-[39], wherein the bonding region comprises a plurality of point bonds, each point bond comprising one of the protrusions that is bonded to one of the complementary depressions.

Embodiment [41] of the present disclosure relates to the article according to Embodiment [40], wherein the plurality of point bonds comprises at least one selected from the group consisting of a circular-shaped point bond, an oval-shaped point bond and a polygonyl-shaped point bond.

Embodiment [42] of the present disclosure relates to the article according to Embodiment [40] or [41], wherein the plurality of point bonds comprises a circular-shaped point bond.

Embodiment [43] of the present disclosure relates to the article according to Embodiment [42], wherein the plurality of point bonds are all circular-shaped point bonds.

Embodiment [44] of the present disclosure relates to the article according to any of Embodiments [1]-[43], wherein the bonding region comprises at least 2 of the point bonds.

Embodiment [45] of the present disclosure relates to the article according to any of Embodiments [1]-[44], wherein the bonding region comprises from 10 point bonds to 50 point bonds.

Embodiment [46] of the present disclosure relates to the article according to any of Embodiments [38]-[45], wherein each point bond conjoins one of the protrusions to one of the complementary depressions by melt bonding.

Embodiment [47] of the present disclosure relates to the article according to any of Embodiments [1]-[46], wherein the bonding region includes a pattern of bonds showing a printed word or object.

Embodiment [48] of the present disclosure relates to the article according to Embodiment [47], wherein the pattern of bonds shows a logo.

Embodiment [49] of the present disclosure relates to the article according to any of Embodiments [1]-[48], wherein the bonding region bonds the label substrate to the closure substrate with a lap shear strength of at least 130 N, as measured when the bonded article is at room temperature.

Embodiment [50] of the present disclosure relates to the article according to any of Embodiments [1]-[49], wherein the bonding region bonds the label substrate to the closure substrate with a lap shear strength of at least 115 N, as measured when the bonded article is at a temperature of about −10 °C.

Embodiment [51] of the present disclosure relates to the article according to any of Embodiments [1]-[50], wherein the bonding region bonds the label substrate to the closure substrate with a lap shear strength of at least 110 N, as measured when the bonded article is at a temperature of about 100 °C.

Embodiment [52] of the present disclosure relates to the article according to any of Embodiments [1]-[51], wherein the bonding region bonds the label substrate to the closure substrate with a lap shear strength of at least 100 N, as measured within 30 seconds of removing the bonded article from a steam sterilization process conducted in an autoclave at a temperature of about 120 °C under a pressure of about 1 atm.

Embodiment [53] of the present disclosure relates to the article according to any of Embodiments [1]-[52], wherein the bonding region bonds the label substrate to the closure substrate without an adhesive.

Embodiment [54] of the present disclosure relates to the article according to any of Embodiments [1]-[53], wherein the bonding region has a surface area ranging from about 0.1 in² to about 1.0 in².

Embodiment [55] of the present disclosure relates to the article according to any of Embodiments [1]-[54], which is formed by ultrasonic welding.

Embodiment [56] of the present disclosure relates to a method for preparing the bonded article according to any one of Embodiments [1]-[55], the method comprising: placing the label substrate atop the closure substrate such that a lower flat portion of the label substrate contacts an upper flat portion of the closure substrate, wherein the contacted lower and upper flat portions constitute an overlap region; and while applying a downward force from an ultrasonic sonotrode to an upper flat portion of the label substrate within the overlap region, applying ultrasonic energy from the ultrasonic sonotrode to the upper flat portion of the label substrate, thereby causing a portion of the first polymer in the overlap region and a portion of the second polymer in the overlap region to bond together and form the bonding region of the bonded article.

Embodiment [57] of the present disclosure relates to the method according to Embodiment [56], further comprising (iii) repeating the bonding step (ii) at least once to further bond the label substrate to the closure substrate.

Embodiment [58] of the present disclosure relates to the method according to Embodiment [56] or [57], wherein the closure substrate is in the form of a multi-closure strip comprising a plurality of connected closure substrates that are linearly attached by one or more removable tabs.

Embodiment [59] of the present disclosure relates to the method according to any of Embodiments [56]-[58], wherein a linear speed at which the label substrate is bonded to the closure substrate ranges from about 1 foot/min to about 200 foot/min, as measured relative to a lateral width of the closure substrate.

Embodiment [60] of the present disclosure relates to the method according to any of Embodiments [56]-[58], wherein a bonding time during which the downward force and the ultrasonic energy are applied to the upper flat portion of the label substrate independently ranges from about 5 ms to about 300 ms.

Embodiment [61] of the present disclosure relates to the method according to any of Embodiments [56]-[60], wherein the downward force ranges from about 200 N to about 700 N.

Embodiment [62] of the present disclosure relates to the method according to any of Embodiments [56]-[61], wherein the ultrasonic sonotrode is constructed of at least one metal selected from the group consisting of aluminum, steel and titanium.

Embodiment [63] of the present disclosure relates to the method according to any of Embodiments [56]-[62], wherein the ultrasonic sonotrode is constructed of titanium.

Embodiment [64] of the present disclosure relates to the method according to any of Embodiments [56]-[63], wherein an output tip of the ultrasonic sonotrode has a textured surface.

Embodiment [65] of the present disclosure relates to the method according to Embodiment [64], wherein the textured surface comprises a knurled surface, a surface having at least one geometric feature, a surface having at least one point feature, or a combination thereof.

Embodiment [66] of the present disclosure relates to the method according to any of Embodiments [56]-[65], wherein an output tip of the ultrasonic sonotrode comprises a plurality of pins.

Embodiment [67] of the present disclosure relates to the method according to Embodiment [66], wherein the plurality of pins comprises at least one selected from the group consisting of a circular-shaped pin, an oval-shaped pin and a polygonyl-shaped pin.

Embodiment [68] of the present disclosure relates to the method according to Embodiment [66] or [67], wherein the plurality of pins comprises a circular-shaped pin.

Embodiment [69] of the present disclosure relates to the method according to Embodiment [68], wherein the plurality of pins are all circular-shaped pins.

Embodiment [70] of the present disclosure relates to the method according to any of Embodiments [56]-[69], wherein an output tip of the ultrasonic sonotrode comprises at least 2 pins.

Embodiment [71] of the present disclosure relates to the method according to any of Embodiments [56]-[70], wherein an output tip of the ultrasonic sonotrode comprises from 10 pins to 50 pins.

Embodiment [72] of the present disclosure relates to the method according to any of Embodiments [66]-[71], wherein a height of the pins on the output tip of the ultrasonic sonotrode independently ranges from about 0.005 inch to about 0.10 inch.

Embodiment [73] of the present disclosure relates to the method according to any of Embodiments [56]-[72], wherein an incident angle of the ultrasonic sonotrode is about 0 degrees, as measured from the normal of the upper flat portion of the label substrate.

Embodiment [74] of the present disclosure relates to the method according to any of Embodiments [56]-[73], wherein the ultrasonic sonotrode is a treated ultrasonic sonotrode having increased lifespan compared to an untreated ultrasonic sonotrode.

Embodiment [75] of the present disclosure relates to the method according to Embodiment [74], wherein the treated ultrasonic sonotrode was treated with a longevity treatment selected from the group consisting of heat treatment, surface treatment, and a combination thereof.

Embodiment [76] of the present disclosure relates to the method according to Embodiment [75], wherein the longevity treatment comprises an electroless nickel surface treatment, a carbide surface treatment, or a combination thereof.

Embodiment [77] of the present disclosure relates to the method according to any of Embodiments [56]-[76], wherein an ultrasonic frequency of the ultrasonic energy ranges from about 10 kHz to about 50 kHz.

Embodiment [78] of the present disclosure relates to the method according to any of Embodiments [56]-[77], wherein the ultrasonic energy ranges from about 100 W to about 2000 W.

Embodiment [79] of the present disclosure relates to the method according to any of Embodiments [56]-[78] wherein the ultrasonic energy is applied to the upper flat portion of the label substrate as longitudinal ultrasonic energy.

Embodiment [80] of the present disclosure relates to the method according to any of Embodiments [56]-[79], wherein the ultrasonic energy is applied to the upper flat portion of the label substrate as torsional ultrasonic energy.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A bonded article comprising a label substrate bonded to a closure substrate via a bonding region, wherein:
the label substrate comprises a first polymer, and the closure substrate comprises a second polymer, wherein the first and second polymers are chemically compatible for ultrasonic bonding together;
the label substrate is in the form of a sheet having a thickness of less than about 0.02 inch, and the closure substrate is in the form of a flat plastic body having a thickness at least 2.5 times greater than the thickness of the label substrate and having an elongation at break of 25% or less;
the bonding region comprises a portion of the label substrate laterally bonded to a portion of the closure substrate, wherein the portion of the label substrate has a plurality of protrusions extending outwardly from a first conjoined surface, and the portion of the closure substrate has a plurality of complementary depressions extending inwardly from a second conjoined surface that faces the first conjoined surface, wherein at least one protrusion on the first conjoined surface of the label substrate bonds to at least one complementary depression on the second conjoined surface of the closure substrate; and
the bonding region bonds the label substrate to the closure substrate with a lap shear strength of at least 100 N.

2. (canceled)

3. The bonded article according to claim 1, wherein the first and second polymers independently comprise at least one selected from the group consisting of a polyolefin, a polyacrylate, a polystyrene (PS), a styrene-butadiene (SB) polymer, a polyacrylonitrile (PAN), an acrylonitrile-butadiene-styrene (ABS) polymer, a polyacrylonitrile-ethylene-propylene-diene-styrene copolymer (A-EPDM), a polycarbonate (PC), an ABS/PC alloy, a polyester, a polyhydroxyalkanoate, a phenolic resin, a urea resin, a melamine resin, an alkyd resin, an epoxy resin, a polylactic acid (PLA), a polyurethane (PU), a polyether, a polyvinyl alcohol (PVA), a polyamide (PA), a polyetherimide (PEI), a polyethersulfone (PES), a polysulfone, a polyvinylchloride (PVC), a polyoxymethylene (POM), a styrene-acrylonitrile (SAN), an acrylonitrile-styrene-acrylate (ASA), a styrene-acrylate (NAS), a SAN-NAS-ASA alloy, a polybutylene terephthalate (PBT), a PBT/PC alloy, a polyethylene tetraphthalate (PET), a polyether ether ketone (PEEK), a poly(phenylene oxide) (PPO), a polyphenylene sulfide (PPS), a polysaccharide, a fluoropolymer, a liquid crystal polymer (LCP), and copolymers thereof.

4. (canceled)

5. The bonded article according to claim 14, wherein at least one of the first polymer and the second polymer, independently, further comprises at least one selected from the group consisting of a polyacrylonitrile (PAN), a polyacrylonitrile-ethylene-propylene-diene-styrene copolymer (A-EPDM), a polyester, a polyhydroxyalkanoate, a phenolic resin, a urea resin, a melamine resin, an alkyd resin, an epoxy resin, a polylactic acid (PLA), a polyurethane (PU), a polyether, and a polyvinyl alcohol (PVA).

6. (canceled)

7. The bonded article according to claim 1, wherein each of the first and second polymers is selected from the group consisting of a polyolefin, a polyamide (PA), a polyoxymethylene (POM), a polybutylene terephthalate (PBT), a polyethylene tetraphthalate (PET), a polyether ether ketone (PEEK), a polyphenylene sulfide (PPS), a polysaccharide, a fluoropolymer, and a liquid crystal polymer (LCP).

8. The bonded article according to claim 1, wherein each of the first and second polymers is a polyolefin.

9-14. (canceled)

15. The article according to claim 1, wherein the flat plastic body has an access opening and a closure central aperture, such that the access opening joins the closure central aperture to define a continuous space.

16-18. (canceled)

19. The article according to claim 1, wherein closure substrate further comprises at least one filler.

20-21. (canceled)

22. The article according to claim 1, wherein the closure substrate further comprises at least one organic filler.

23-24. (canceled)

25. The article according to claim 1, wherein the closure substrate satisfies at least one of the following properties:
(i) a melting point ranging from about 120 °C to about 180 °C;
(ii) a density ranging from about 0.8 g/cm³ to about 1.6 g/cm³;
(iii) a tensile strength ranging from about 15 MPa to about 35 MPa;
(iv) a tensile modulus ranging from about 1500 MPa to about 3000 MPa;
(v) a flexural modulus ranging from about 2000 MPa to about 5000 MPa;
(vi) an elongation at break ranging from about 1% to about 20%;
(vii) an impact strength ranging from about 10 J/m to about 20 J/m;
(viii) an Izod impact strength ranging from about 10 J/m to about 40 J/m (notched), and from about 100 J/m to about 250 J/m (unnotched); and
(ix) a Shore D hardness ranging from about 40 to about 100, and a Rockwell R hardness ranging from about 60 to about 130.

26-28. (canceled)

29. The article according to claim 1, wherein a surface energy of the label substrate ranges from about 25 dyne to about 45 dyne.

30. The article according to claim 1, wherein label substrate further comprises at least one filler.

31-32. (canceled)

33. The article according to claim 1, wherein the label substrate further comprises at least one organic filler.

34-35. (canceled)

36. The article according to claim 1, wherein the label substrate satisfies at least one of the following properties:
(i) a melting point ranging from about 120 °C to about 180 °C;
(ii) a density ranging from about 0.8 g/cm³ to about 1.6 g/cm³;
(iii) a tensile strength ranging from about 15 MPa to about 35 MPa;
(iv) a tensile modulus ranging from about 800 MPa to 1500 MPa;
(v) a flexural modulus ranging from about 1000 MPa to about 4000 MPa;
(vi) an elongation at break ranging from about 10% to about 700%;
(vii) an impact strength ranging from about 10 J/m to about 20 J/m;
(viii) an Izod impact strength ranging from about 10 J/m to about 40 J/m (notched), and from about 100 J/m to about 250 J/m (unnotched); and
(ix) a Shore D hardness ranging from about 40 to about 100, and a Rockwell R hardness ranging from about 60 to about 130.

37. (canceled)

38. The article according to claim 1, wherein the conjoined surface of the label substrate is a textured surface comprising the at least one protrusion that bonds to the complementary depression of the closure substrate.

39. (canceled)

40. The article according to claim 1, wherein the bonding region comprises a plurality of point bonds, each point bond comprising one of the protrusions that is bonded to one of the complementary depressions.

41-51. (canceled)

52. The article according to claim 1, wherein the bonding region bonds the label substrate to the closure substrate with a lap shear strength of at least 100 N, as measured within 30 seconds of removing the bonded article from a steam sterilization process conducted in an autoclave at a temperature of about 120 °C under a pressure of about 1 atm.

53. The article according to claim 1, wherein the bonding region bonds the label substrate to the closure substrate without an adhesive.

54-55. (canceled)

56. A method for preparing the bonded article according to claim 1, the method comprising:
(i) placing the label substrate atop the closure substrate such that a lower flat portion of the label substrate contacts an upper flat portion of the closure substrate, wherein the contacted lower and upper flat portions constitute an overlap region; and
(ii) while applying a downward force from an ultrasonic sonotrode to an upper flat portion of the label substrate within the overlap region, applying ultrasonic energy from the ultrasonic sonotrode to the upper flat portion of the label substrate, thereby causing a portion of the first polymer in the overlap region and a portion of the second polymer in the overlap region to bond together and form the bonding region of the bonded article.

57-63. (canceled)

64. The method according to claim 56, wherein an output tip of the ultrasonic sonotrode has a textured surface.

65. (canceled)

66. The method according to claim 56, wherein an output tip of the ultrasonic sonotrode comprises a plurality of pins.

67-78. (canceled)

79. The method according to claim 56, wherein the ultrasonic energy is applied to the upper flat portion of the label substrate as longitudinal ultrasonic energy or as torsional ultrasonic energy.

80. (canceled)
